(19) United States
(12) Patent Application Publication
(10) Pub. No.: US 2008/0294882 A1
(43) Pub. Date: Nov. 27, 2008

(54) DISTRIBUTED LOOP CONTROLLER ARCHITECTURE FOR MULTI-THREADING IN UNI-THREADED PROCESSORS

(75) Inventors: Murali Jayapala, Leuven (BE); Praveen Raghavan, Trichy (IN); Franchy Catthoor, Temse (BE)

Correspondence Address: KNOBBE MARTENS OLSON & BEAR LLP, 2040 MAIN STREET, FOURTEENTH FLOOR, IRVINE, CA, 92614, US

(73) Assignees: Interuniversitair Microelektronica Centrum vzw (IMEC), Leuven (BE); Katholieke Universiteit leuven, K.U. Leuven R&D, Leuven (BE)

(21) Appl. No.: 12/129,559

(22) Filed: May 29, 2008

Related U.S. Application Data
(63) Continuation of application No. PCT/EP2006/011655, filed on Dec. 5, 2006.

(30) Foreign Application Priority Data
Dec. 5, 2005 (GB) 0524720.0

(51) Int. Cl. G06F 9/30

(52) U.S. Cl. 712/241; 712/E09.016

(57) ABSTRACT

In one aspect, a virtually multi-threaded distributed instruction memory hierarchy that can support the execution of multiple incompatible loops in parallel is disclosed. In addition to regular loops, irregular loops with conditional constructs and nested loops can be mapped. The loop buffers are clustered, each loop buffer having its own local controller, and each local controller is responsible for indexing and regulating accesses to its loop buffer.

### CROSS REFERENCE TO RELATED APPLICATIONS

This application is a continuation of PCT Application No. PCT/EP2006/011655, filed Dec. 5, 2006, which is incorporated by reference hereby in its entirety.

### BACKGROUND OF THE INVENTION

1. Field of the Invention

The present invention relates to a microcomputer architecture with reduced power consumption and performance enhancement, and to methods of designing and operating the same.

2. Description of the Related Technology

Modern embedded applications and mobile terminals need to support increasingly complex algorithms for wireless communication and multimedia. They need to combine the high computational complexity of these standards with an extreme energy efficiency to be able to provide a sustained operation over long periods of time with no or minimal recharging of the battery. In some cases, like sensor-networks and in-vivo biomedical implants, battery-less operation may be preferred, where power is obtained by scavenging energy sources. In order to achieve such low power constraints it is desired that the energy consumption is reduced in all parts of the system.

Therefore, the embedded systems designer has to look at the complete system and tackle the power problem in each part. Energy consumption is application dependent and therefore the designer needs to minimize the energy required to finish a certain task, while respecting the performance requirements. It is important to focus on energy, as energy is what is drawn from a battery. The (peak) power consumption is of secondary importance, but still has to be controlled, because it influences production costs, like packaging.

Most energy efficient techniques that are currently used, reduce the power consumption of application specific instruction set processors (ASIPs), but do not attack the core bottleneck of the power problem viz. the instruction memory hierarchy and the register file.

Instruction memory hierarchy has been proven to be one of the most power hungry parts of the system, see Andy Lambrechts, Praveen Raghavan, Anthony Leroy, Guillermo Talayera, Tom Van der Aa, Murali Jayapala, Francky Catthoor, Diederik Verkest, Geert Deconinck, Henk Coporaal, Frederic Robert, and Jordi Carrabina, “Power breakdown analysis for a heterogeneous NoC platform running a video application”, Proc of IEEE 16th International Conference on Application-specific Systems, Architectures and Processors (ASAP), pages 179-184, July 2005. The instruction memory energy bottleneck becomes more apparent after techniques like loop transformations, software controlled caches, data layout optimizations (see Rajeshwari Banakar, Stefan Steinke, Bo-Sik Lee, M. Balakrishnan, and Peter Marwedel, “Scratchpad memory: A design alternative for cache on-chip memory in embedded systems”, Proc of CODES, May 2002, and M. Kandemir, I. Kadayif, A. Choudhary, J. Ramanujam, and I. Kolcu, “Compilerdirected scratch pad memory optimization for embedded multiprocessors.”, IEEE Trans on VLSI, pages 281-287, March 2004), and distributed register files (see Scott Rixner, William J. Dally, Brucek Khailany, Peter R. Mattson, Ujval J. Kapasi, and John D. Owens, “Register organization for media processing”, HPCA, pages 375-386, January 2000; and Viktor Lapinskii, Margarida F. Jacome, and Gustavo de Veciana, “Application-specific clustered VLIW datapaths: Early exploration on a parameterized design space”, IEEE Transactions on Computer Aided Design of Integrated Circuits and Systems, 21(8):889-903, August 2002) have been applied to lower the energy consumption of other components of the system.

Reduced energy consumption is thus one of the most important design goals for embedded application domains like wireless, multimedia and biomedical.

State of the art architecture enhancements to reduce the energy consumed in the instruction memory hierarchy for very long instruction word (VLIW) processors include
using loop buffers, as in M. Jaypala, T. Vanderaa, et. al., “Clustered Loop Buffer Organization for Low Energy VLIW Embedded Processors”, IEEE Transactions on VLSI, June 2004;
NOP compression, as in Halambi, A. Shrivastava, et. al., “An efficient compiler technique for code size reduction using reduced bit-width ISAs”, Proc of DAC, March 2002;
SILO cache, as in 5 T. M. Conte, S. Banerjia, et. Al., “Instruction fetch mechanisms for VLIW architectures with compressed encodings.”, Proc of 29th International Symposium on Microarchitecture (MICRO), December 1996;
code-size reduction, as in Halambi, A. Shrivastava, et. al., “An efficient compiler technique for code size reduction using reduced bit-width ISAs”, Proc of DAC, March 2002; etc.
   In spite of these enhancements, the instruction memory organizations still have low energy efficiency, as described in M. Jaypala, T. Vanderaa, et. al., “Clustered Loop Buffer Organization for Low Energy VLIW Embedded Processors”, IEEE Transactions on VLSI, June 2004. Hence there is a need for an improved solution. The well-known L0 buffer or loop buffer is an extra level of memory hierarchy that is used to store instructions corresponding to loops. It is a good candidate for a distributed solution as shown in the above Jaypala document. But current distributed loop buffers support only one thread of control. In every instruction cycle, a single loop controller generates an index, which selects/fetches operations from the loop buffers. The loop counter/controller may be implemented in different ways: instruction based or using a separate hardware loop counter. By supporting only one thread of control different incompatible loops cannot be efficiently mapped to different distributed loop buffers.

To improve both performance as well as energy efficiency, platforms and processors try to exploit more parallelism at different levels, as described by H. DeMan in “Ambient intelligence: Giga-scale dreams and nano-scale realities”, Proc of ISSCC, Keynote Speech, February 2005. Since loops form the most important part of a program, on single-threaded architectures, techniques like loop fusion and other loop transformations are applied to exploit the parallelism available within loops (boosting ILP—Instruction Level Parallellism). However, not all loops can be efficiently broken down into parallel operations in this manner, as they may be incompatible (as illustrated in FIG. 1). This incompatibility of loops leads to a large control overhead. Therefore there is a need for a multi-threaded platform that can support execution of multiple loops and in this way exploit more parallelism, while adding minimal hardware/instruction overhead.

The example code shown in FIG. 1 shows two loops with different loop organizations. In the context of embedded systems with software controlled memory hierarchy, the above code structure is realistic. Code 1 gives the loop structure for the code that would be executed on the data path of the processor. Code 2 gives the loop structure for the code that is required for data management in the data memory hierarchy. This may represent the code that fetches data from the external SDRAM and places it on the scratch-pad memory, or to other memory transfer related code. Code 1 can be assumed to execute some operations on the data that was obtained by Code 2. The above code example can be mapped on different platforms. The advantages and disadvantages of mapping such a code on state of the art techniques/systems are described below.

The L0 buffer or loop buffer architecture is a commonly used technique to reduce instruction memory hierarchy energy, as e.g. described by S. Cotterell and F. Vahid in “Synthesis of customized loop caches for core-based embedded systems.”, Proc of International Conference on Computer Aided Design (ICCAD), November 2002, or by M. Jaypala, T. Vanderaa, et. al., in “Clustered Loop Buffer Organization for Low Energy VLIW Embedded Processors”, IEEE Transactions on VLSI, June 2004. This technique proposes an extra level of instruction memory hierarchy which can be used to store loops. Thus, a small loop buffer is used in addition to the large instruction caches/memories, which is used to store only loops or parts of loops. Additionally, several compiler techniques are proposed to improve energy and performance of loop buffering, e.g. by J. W. Sias, H. C. Hunter, et. al., in “Enhancing loop buffering of media and telecommunications applications using low-overhead predication.”, Proc of MICRO, December 2001, or by S. Steinke, L. Wehmeyer, et. al., in “Assigning program and data objects to scratchpad for energy reduction.”, Proc of Design Automation and Test in Europe (DATE), March 2002. State of the art L0 organizations can be categorized based on three aspects: loop buffers, local controllers and thread of control. Loop buffers are memory elements used to store the instructions. Local controllers are the control logic used to index into the loop buffers. The thread of control, as the name suggests, gives the number of threads that can be controlled at a given time. Loop buffers and local controllers can be centralized or distributed. Most state of the art loop buffers and the associated local controllers are centralized, see e.g. S. Cotterell and F. Vahid, “Synthesis of customized loop caches for core-based embedded systems”, Proc of International Conference on Computer Aided Design (ICCAD), November 2002. However for higher energy efficiency both the loop buffers and local controllers can be distributed. Murali Jayapala, Francisco Barat, Tom Vander Aa, Francky Catthoor, Henk Corporaal, and Geert Deconinck, in “Clustered loop buffer organization for low energy VLIW embedded processors”, IEEE Transactions on Computers, 54(6):672-683, June 2005, explore and analyze the distributed aspects of loop buffers and controllers. Additionally, the thread of control can be single or multiple threaded. Currently, all the loop buffer organizations are intended for single thread of control (as illustrated in FIG. 2(b)). Local controllers in this latest document only regulate the accesses to the loop buffers. Some commercial processors, like Starcore DSP Technology, SC140 DSP Core Reference Manual, June 2000, implement the unified loop controller as a hardware counter, but enforce restrictions on handling branches during the loop mode. Other limitations include the need for affine loop bounds for the hardware loop.

State of the Art L0 organizations like the ones shown in FIG. 2(b) allow only single-threaded operation. Although the loop buffers are distributed, they contain a single loop controller and therefore such an organization does not support multi-threaded operation.

In uni-processor platforms, i.e. processors with single thread of control, (FIG. 2(b)), loop fusion is a commonly used technique to execute multiple threads in parallel. By applying loop fusion, the candidate loops with different threads of control are merged into a single loop, with single thread of control. However, with this technique incompatible loops like the one shown in FIG. 1 cannot be handled efficiently. When incompatible loops are merged, manu if-then-else constructs and other control statements are required for the checks on loop iterators. The number of these additional constructs needed can be very large, resulting in loss of both energy and performance. This overhead still remains, even if advanced loop morphing as in J. I. Gómez, P. Marchal, et. al., “Optimizing the memory bandwidth with loop morphing.”, ASAP, pages 213-223, 2004 is applied.

Multi-threaded architectures and Simultaneous Multi-Threaded (SMT) processors, as described by E. Ozer, T. Conte, et. al., “Weld: A multithreading technique towards latency-tolerant VLIW processors.”, International Conference on High Performance Computing, 2001; or by S. Kaxiras, G. Narlikar, et. al., “Comparing power consumption of an SMT and a CMP DSP for mobile phone workloads.”, In Proc of CASES, pages 211-220, November 2001, or by D. M. Tullsen, S. J. Eggers, et. al., “Simultaneous multithreading: Maximizing on-chip parallelism.”, Proc of ISCA, pages 392-403, June 1995, can also execute multiple loops in parallel. In such architectures, each thread has a set of exclusive resources to hold the state of the thread. Typically, each thread has its own register file and program counter logic, as shown in FIG. 2(a). Furthermore, in these architectures the data communication between the processes/threads is done at the cache level (or level-1 data memory). No specific constraints apply on the type of the threads that can be executed: any generic thread (loop and non-loop) can be executed.

However, these architectures are intended for larger granularity tasks than loops. Hence, the overhead of context management and switching is large. The data sharing in these architectures between two processes/threads is done at the cache level, which requires extra reads and writes from/to the memory and register file. SMT processors (shown in FIG. 2(a)) need multiple fetch/decode units and complete program counter logic for each of the threads, which requires extra hardware overhead.

### SUMMARY OF CERTAIN INVENTIVE ASPECTS

Certain inventive aspects relate to a good microcomputer architecture as well as methods of operating the same. An advantage of certain inventive aspects is reduced power consumption.

One inventive aspect proposes a virtually multi-threaded distributed instruction memory hierarchy that can support the execution of multiple incompatible loops in parallel. In addition to regular loops, irregular loops with conditional constructs and nested loops can be mapped. To make the loops fit in the loop buffers, sub-routines and function calls within the loops may be selectively in-lined or optimized using other loop transformations, like code hoisting or loop splitting. Alternatively, sub-routines can be executed from the conventional level-1 instruction cache/scratch-pad if they do not fit in the loop buffers. In an architecture in accordance with embodiments of the present invention, the loop buffers are clustered, each loop buffer having its own local controller, and each local controller is responsible for indexing and regulating accesses to its loop buffer. Some of the novel and inventive contributions in certain inventive aspects may be one or more of the following:
A distributed local controller based loop buffer organization is provided that can efficiently support two modes—single threaded and multi-threaded.
In addition to executing loop nests sequentially and executing multiple compatible loops in parallel, the distributed controllers enable to execute multiple incompatible loops in parallel.
The distributed controller based instruction memory hierarchy is energy efficient and scalable. Additionally, this enhancement improves the performance.

Another inventive aspect proposes support for the execution of multiple threads, in particular for the execution of multiple loops in parallel. In order to support multiple loop execution, the local controllers have additional functionality as detailed below. Local controllers in accordance with embodiments of the present invention provide indices to the loop buffers and may synchronize with other local controllers, in addition to regulating the access to the loop buffers.

It is an advantage of embodiments of the present invention that branches can be present inside the loop mode, either as a branch inside the loop buffer or as a branch outside the loop buffer contents.

Compared to prior art architectures, the multi-threaded architecture in accordance with embodiments of the present invention has at least one or more of the following differentiators. Firstly, the hardware overhead/duplication is minimal. A simplified local controller may provided for each thread. Secondly, the data communication between the threads, in addition to cache level (or level-1 data memory) can also be done at the register file level. Thirdly, the architecture in accordance with embodiments of the present invention may be intended specifically for executing multiple loops. This implies that any generic threads may not be executed in the architecture according to embodiments of the present invention unless the generic threads are pre-transformed into loops. Since the hardware overhead is minimal, the architecture according to embodiments of the present invention is energy efficient. The data and control dependencies between two threads can be analyzed through design/compile time analysis of the loops. Such an analysis is not performed in the prior art Multi-threaded or SMT processors. This analysis improves the performance and energy efficiency, as it may enable to perform efficient data communication between the threads through the register file level. It may also enable to insert synchronization points between the loops. In prior art Multi-threaded or SMT processors, such analysis is not performed. The primary motivation for SMT processors is to improve resource utilization and hence performance, i.e., to fill in the empty instruction cycles of functional units (FUs) from different threads, thus improving performance. Hence, all the threads share all the FUs in the datapath. In the architecture according to embodiments of the present invention, the primary motivation is to improve resource utilization and by doing this reduce energy consumption. As motivated above, each thread has an exclusive set of FUs (FUs in one cluster or group) to minimize interconnect energy and the loops are pre-processed such that computations in each thread use only their exclusive set of FUs. In the architecture enhancement in accordance with embodiments of the present invention (see FIG. 2(c)), multiple loops can be executed in parallel, without the overhead/limitations mentioned above.

Multiple synchronizable Loop Controllers (LCs) enable the execution of multiple loops in parallel as each loop has its own loop controller. This also enables a reduction in the interconnect required between the instruction memory and the datapath. The LC logic is simplified and the hardware overhead is minimal, as it has to execute only loop code. Data sharing and synchronization may be done at the register file level and therefore context switching and management costs are eliminated. A hardware based loop counter is also provided, which is capable of having breaks out of the loop (instruction affects the PC) and conditional/unconditional jumps inside as well (instruction affects the LC and counters). It is also possible to have non-affine loop counts (where the loop bounds are given by variables in registers instead of affine ones at compile-time).

In one aspect, the present invention provides a signal processing device adapted for simultaneous processing of at least two process threads, the process threads in particular being loops, each process thread or loop having instructions in particular loop instructions. The instructions are data access operations, which in case of loops are data access operations to be carried out a number of times in a number of loop iterations. The signal processing device comprises a plurality of functional units capable of executing word- or subword-level operations, to be distinguished from bit-level operations, on data, and grouped into a plurality of processing units or clusters. Each of the processing units are connected to a different instruction memory, also called loop buffer, for receiving loop instructions of one of the loops and to a different memory controller, also called loop controller, for accessing the instruction memory in order to fetch loop instructions from the corresponding instruction memory. The memory controllers of the signal processing device in accordance with one inventive aspect are adapted for selecting operation synchronized or unsynchronized with respect to each other, the selection being performed via the loop instructions.

According to embodiments of the present invention, the memory controllers may each at least include a slave loop counter. The signal processing device may have a master counter or clock for providing a timing signal and the slave loop counters may be connected to the master counter for receiving the timing signal. When two memory controllers are selecting operation synchronized with respect to each other, the slave loop counters of at least two memory controllers are synchronously incremented upon reception of the timing signal. The timing signal may comprise a sequence of time points, and the selection may be performed via the loop instructions at every time point.

According to embodiments of the present invention, the master counter may be a system clock generator for providing a clock signal with clock cycles. The selection may then be performed at every clock cycle.

According to embodiments of the present invention, the slave loop counter may be a hardware loop counter or a software loop counter.

According to embodiments of the present invention, at least two functional units may be connected to a shared data memory, which may be a register.

According to embodiments of the present invention, a memory controller may be a program counter adapted for verifying loop boundary addresses, i.e. start and stop address of the loop instructions in the instruction memory.

According to embodiments of the present invention, a memory controller may be adapted for indexing its related instruction memory, also called loop buffer, and may be capable of synchronizing with another memory controller. Such capability of synchronizing with another memory controller may be obtained via loop instruction code, e.g. via selection information inserted into the loop instruction code. The selection information may consist of one or more bits.

According to embodiments of the present invention, the memory controllers may include two registers.

In another aspect, the present invention provides a method for converting application code into execution code suitable for execution on an architecture as defined hereinabove. The architecture comprises a plurality of functional units capable of executing word- or subword-level operations, to be distinguished from bit-level operations, on data, the functional units being grouped into a plurality of processing units or clusters. Each of the processing units are connected to a different instruction memory, also called loop buffer, for receiving loop instructions of one of the loops and to a different memory controller, also called loop controller, for accessing the instruction memory in order to fetch loop instructions from the corresponding instruction memory. The memory controllers of the architecture are adapted for selecting operation synchronized or unsynchronized with respect to each other, the selection being performed via the loop instructions. The method comprises obtaining application code, the application code comprising at least two, a first and a second, process threads, in particular loops, each of the process threads including instructions, the instructions in particular for loops being loop instructions. The instructions are data access operations, and in case of loops these data access operations are to be carried out in a number of loop iterations. The method in accordance with this aspect of the present invention furthermore also comprises converting at least part of the application code for the at least two process threads, in particular the first and the second loops. The converting includes insertion of selection information into each of the instructions, in particular into the loop instructions, the selection information being for fetching a next instruction, in particular a next loop instruction, of a first process thread, in particular of a first loop, synchronized or unsynchronized with the fetching of a next instruction, in particular a next loop instruction, of a second process thread, in particular a second loop. The converting application code in accordance with this aspect of the present invention is particularly good for converting code comprising at least two loops each having a nesting structure, the at least two loops being non-overlapping in their nesting structure, i.e. the at least two loops being incompatible loops.

According to embodiments of the present invention, the converting may be adapted so that, when executing the at least two process threads, e.g. loops, simultaneously, each process thread, e.g. loop, executing on one of the processing units, selecting of the fetching of next instructions, e.g. loop instructions, is performed at time points of a time signal. The converting may furthermore comprise providing the time signal having time points. This means that a counter may be implemented.

According to embodiments of the present invention, the converting of at least part of the application code may be based on a time/data dependency analysis.

According to embodiments of the present invention, at least part of the data communication between the process threads, e.g. loops, is performed solely via a shared data memory to which at least two functional units are connected to a shared data memory. The shared data memory may be a register.

According to embodiments of the present invention, the converting may include inserting synchronization or alignment points between the at least two process threads, e.g. loops. The insertion may require at most a number of bits equal to the number of processing units minus one.

According to embodiments of the present invention, the data dependency analysis may be based on a polyhedral representation of the at least two process threads, e.g. loops.

According to embodiments of the present invention, the application code may be pre-processed to fit into a polyhedral representation before the process of converting.

According to embodiments of the present invention, the application code may be pre-processed such that for at least two process threads, e.g. loops, their instructions fit within one of the instruction memories.

In a further aspect of the present invention, a method for executing an application on a signal processing device as defined hereinabove. The signal processing device comprises a plurality of functional units capable of executing word- or subword-level operations, to be distinguished from bit-level operations, on data, the functional units being grouped into a plurality of processing units or clusters. Each of the processing units are connected to a different instruction memory, also called loop buffer, for receiving loop instructions of one of the loops and to a different memory controller, also called loop controller, for accessing the instruction memory in order to fetch loop instructions from the corresponding instruction memory. The memory controllers of the signal processing device are adapted for selecting operation synchronized or unsynchronized with respect to each other, the selection being performed via the loop instructions. The method comprises executing the application on the signal processing device as a single process thread under control of a primary memory controller, and dynamically switching the signal processing device into a device with at least two non-overlapping processing units or clusters, and splitting a portion of the application in at least two process threads, e.g. loops, each process thread being executed simultaneously as a separate process thread on one of the processing units, each processing unit being controlled by a separate memory controller.

According to embodiments of the present invention, the method may comprise, for at least part of the application, synchronization between the at least two process threads, e.g. loops. This way, the process threads, e.g. loops, are in lock-step. The process thread execution, e.g. loop execution, is adapted in accordance with synchronization points between the at least two process threads, e.g. loops.

In yet another aspect, the present invention provides a microcomputer architecture comprising a microprocessor unit and a first memory unit, the microprocessor unit comprising a functional unit and at least one data register, the functional unit and the at least one data register being linked to a data bus internal to the microprocessor unit. The data register is a wide register comprising a plurality of second memory units which are capable to each contain one word. The wide register is adapted so that the second memory units are simultaneously accessible by the first memory unit, and at least part of the second memory units are separately accessible by the functional unit. In accordance with embodiments of the present invention, there is an alignment in the layout between the memory unit and the at least one data register.

In accordance with embodiments of the present invention, the memory unit may have a plurality of sense amplifiers and the at least one data register may have a plurality of flip flops, in which case there may be an alignment between each of the sense amplifiers and a corresponding flip flop.

The proposed aligned microcomputer architecture may be adapted such that it can exploit the concept of selective synchronization of memory controllers.

In still another aspect, the present invention provides a method for designing on a computer environment a digital system comprising a plurality of resources. The method comprises inputting a representation of the functionality of the digital system, e.g. an RTL description thereof, the functionality being distributed over at least two of the resources interconnected by a resource interconnection, and performing automatedly determining an aspect ratio of at least one of the resources based on access activity of the resources while optimizing a cost criterion at least including resource interconnection power consumption cost.

According to embodiments of the present invention, the method may furthermore comprise, for at least one of the resources, placement of communication pins based on access activity of the resources while optimizing a cost criterion at least including resource interconnection power consumption cost. This pin placement may be performed at the same time as the determining of the aspect ratio of the resource. Alternatively, it may be performed after having determined the aspect ratio of the resource. According to still an alternative embodiment, pin placement of a resource may be performed before determination of the aspect ratio thereof.

According to embodiments of the present invention, the method may furthermore comprise, for at least two resources together, placement of communication pins based on access activity of the resources while optimizing a cost criterion at least including resource interconnection power consumption cost. The placement of the communication pins of the at least two resources may include alignment of the communication pins of a first of the two resources with the communication pins of a second of the two resources.

It is an advantage of the embodiments of the present invention that devices and methods with reduced power consumption are obtained.

The proposed layout methods are especially advantageous for the aligned microcomputer architecture, the microcomputer architecture exploiting the concept of selective synchronization of memory controllers and/or a combination of these.

In another aspect, a signal processing device adapted for simultaneous processing of at least two loops, each loop having loop instructions, is disclosed. The signal processing device comprises a plurality of functional units capable of executing word- or subword-level operations on data, and the functional units being grouped into at least a first and a second processing units, the first and second processing units being connected to a first and second instruction memory, respectively, for receiving loop instructions of one of the loops and being connected to a first and a second memory controller, respectively, for fetching loop instructions from the corresponding instruction memory, wherein the first and second memory controllers are adapted for selecting its/their operation synchronized or unsynchronized with respect to each other, the selection being performed via the loop instructions.

In another aspect, a method of converting application code into execution code suitable for execution on an architecture adapted for simultaneous processing of at least two loops, each loop having loop instructions, is disclosed. The method comprises obtaining application code, the application code comprising at least a first and a second loop, each of the loops comprising loop instructions. The method further comprises converting at least part of the application code for the at least first and second loops, the converting comprising insertion of selection information into each of the loop instructions, the selection information being for fetching a next loop instruction of a first loop, synchronized or unsynchronized with the fetching of a next loop instruction of a second loop.

In another aspect, a method of executing an application on a signal processing device adapted for simultaneous processing of at least two loops, each loop having loop instructions, is disclosed. The method comprises executing the application on the signal processing device as a single process thread under control of a primary memory controller. The method further comprises dynamically switching the signal processing device into a device with at least two non-overlapping processing units, and splitting a portion of the application in at least two process threads, each process thread being executed simultaneously as a separate process thread on one of the processing units, each processing unit being controlled by a separate memory controller.

In another aspect, a microcomputer architecture is disclosed. The microcomputer architecture comprises a microprocessor unit and a first memory unit, the microprocessor unit comprising a functional unit and at least one data register, the functional unit and the at least one data register being linked to a data bus internal to the microprocessor unit, the data register being a wide register comprising a plurality of second memory units which are capable to each contain one word, the wide register being adapted so that the second memory units are simultaneously accessible by the first memory unit, and at least part of the second memory units are separately accessible by the functional unit, wherein there is an alignment between the memory unit and the at least one data register.

In another aspect, a method of designing on a computer environment a digital system comprising a plurality of resources is disclosed. The method comprises inputting a representation of the functionality of a digital system, the functionality being distributed over at least two of the resources interconnected by a resource interconnection. The method further comprises performing automated determination of an aspect ratio of at least one of the resources based on access activity of the resources while optimizing a cost criterion at least comprising resource interconnection power consumption cost.

Particular and preferred aspects of the invention are set out in the accompanying independent and dependent claims. Features from the dependent claims may be combined with features of the independent claims and with features of other dependent claims as appropriate and not merely as explicitly set out in the claims.

The above and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

### BRIEF DESCRIPTION OF THE DRAWINGS

FIG. 1 illustrates a simple example of incompatible loop organizations.

FIG. 2 illustrates different processor architectures supporting multi-threading. Part (a) of FIG. 2 is a schematic block diagram of part of a simultaneous multi-threaded (SMT) processor, part (b) of FIG. 2 is a schematic block diagram of part of a uni-processor platform with single loop controller, and part (c) of FIG. 2 is a schematic block diagram of part of a uni-processor platform with distributed loop controller in accordance with embodiments of the present invention.

FIG. 3 illustrates an L0 controller for use with embodiments in accordance with the present invention.

FIG. 4 illustrates an L0 controller based on hardware loops, for use with embodiments in accordance with the present invention.

FIG. 5 shows an example of assembly code for a hardware loop counter based solution.

FIG. 6 illustrates a state diagram illustrating the switching between single and multi-threaded mode of operation.

FIG. 7 illustrates assembly code for the code shown in FIG. 1, with extra synchronization bits being shown in brackets.

FIG. 8 illustrates an experimental set-up used for simulation and energy/performance estimation.

FIG. 9 illustrates instruction memory energy savings normalized to sequential execution

FIG. 10 illustrates performance comparison normalized to sequential execution.

FIG. 11 illustrates energy breakdown of different architectures.

FIG. 12 illustrates the evolution of interconnect energy consumption with technology scaling.

FIG. 13 illustrates an example of an architecture as described in EP-05447054.7, for which the layout optimization of embodiments of the present invention can be used.

FIG. 14 illustrates a technique to optimize aspect ratio and pin placement of different modules in a design in accordance with embodiments of the present invention.

FIG. 15 illustrates a design flow for the experimentation and implementation flow according to embodiments of the present invention

FIG. 16 shows the layout after place and route for a Flat Design of an example structure.

FIG. 17 shows a layout for a Modular Design with default shape and default pin placement (DS_DP).

FIG. 18 shows a layout which is shaped in accordance with embodiments of the present invention and has default pin placement (S_DP).

FIG. 19 shows a layout which has default shape but has undergone pin placement in accordance with one embodiment (DS_PP).

FIG. 20 shows a layout which is shaped in accordance with embodiments of the present invention and has undergone pin placement in accordance with embodiments of the present invention (S_PP).

FIG. 21 shows a zoomed in layout as in FIG. 20 (S_PP).

FIG. 22 illustrates design capacitance of the different designs of FIGS. 16 to 20.

### DETAILED DESCRIPTION OF CERTAIN ILLUSTRATIVE EMBODIMENTS

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not correspond to actual reductions to practice of the invention.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

Similarly, it is to be noticed that the term “coupled”, also used in the claims, should not be interpreted as being restricted to direct connections only. Thus, the scope of the expression “a device A coupled to a device B” should not be limited to devices or systems wherein an output of device A is directly connected to an input of device B. It means that there exists a path between an output of A and an input of B which may be a path including other devices or means.

The invention will now be described by a detailed description of several embodiments of the invention. It is clear that other embodiments of the invention can be configured according to the knowledge of persons skilled in the art without departing from the true spirit or technical teaching of the invention, the invention being limited only by the terms of the appended claims.

Most embedded code is loop code. Instead of accessing the large L1 instruction memory for every instruction, the loop code can be buffered inside a smaller local memory called a loop buffer. Another property of embedded systems is that the amount of coarse grained parallelism across applications is low as the number of threads running in parallel is low. Therefore the parallelism has to be exploited at the sub-task level, across different loops of the same application (which may have dependencies). For executing these loops, usually software instructions are used which decrement a register, compare and branch on a condition. Since looping is very common for embedded systems, it is beneficial to convert this branch instructions into a hardware based loop counter, which is the case in nearly all state of the art DSPs (zero overhead looping). But these DSPs cannot run multiple loops in parallel (do not support SMT—simultaneous multi-threading).

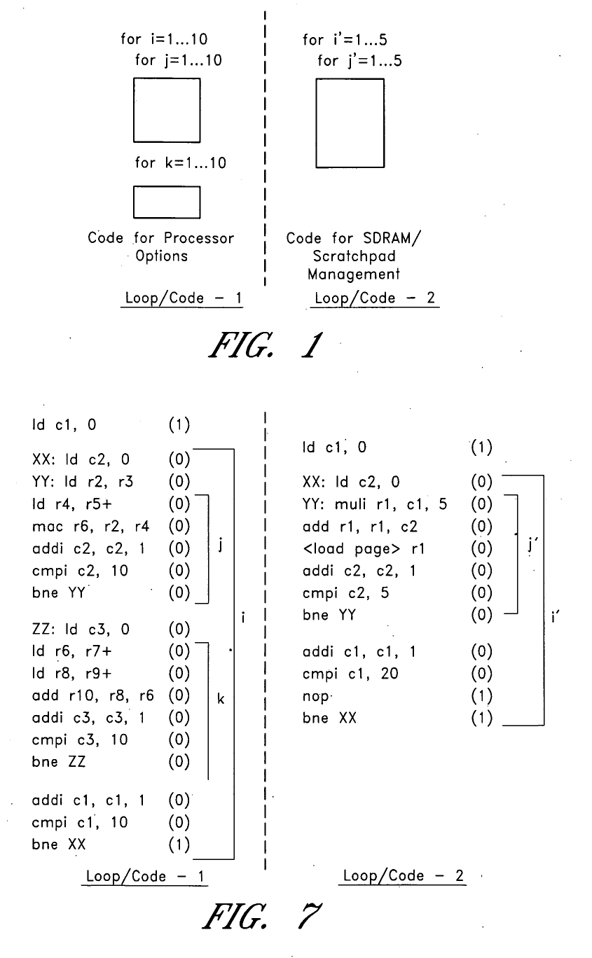

Different loops across a same application can have very different loop characteristics (e.g memory operation dominated vs. computation dominated or different loop boundaries, loop iterator strides etc.). The example code shown in FIG. 1 shows two loops with different loop organizations. Code 1 gives a loop structure for the computational code that would be executed on the data path of the processor. Code 2 gives the loop structure for the corresponding code that is required for data and address management in the data memory hierarchy that would be executed on the address management/generation unit of the processor. This may represent the code that fetches data from the external SDRAM and places it on the scratch-pad memory (or other memory transfer related operations). Code 1 in this example executes some operations on the data that was fetched by Code 2. In the context of embedded systems with software controlled data memory hierarchy, the above code structure is realistic. The above code example can be mapped on different platforms. These two codes could also represent two parts/clusters of a VLIW executing two blocks of an algorithm, where each cluster could be customized for executing that particular block. Hence need is present for a distributed control of two or more separate sets of codes.

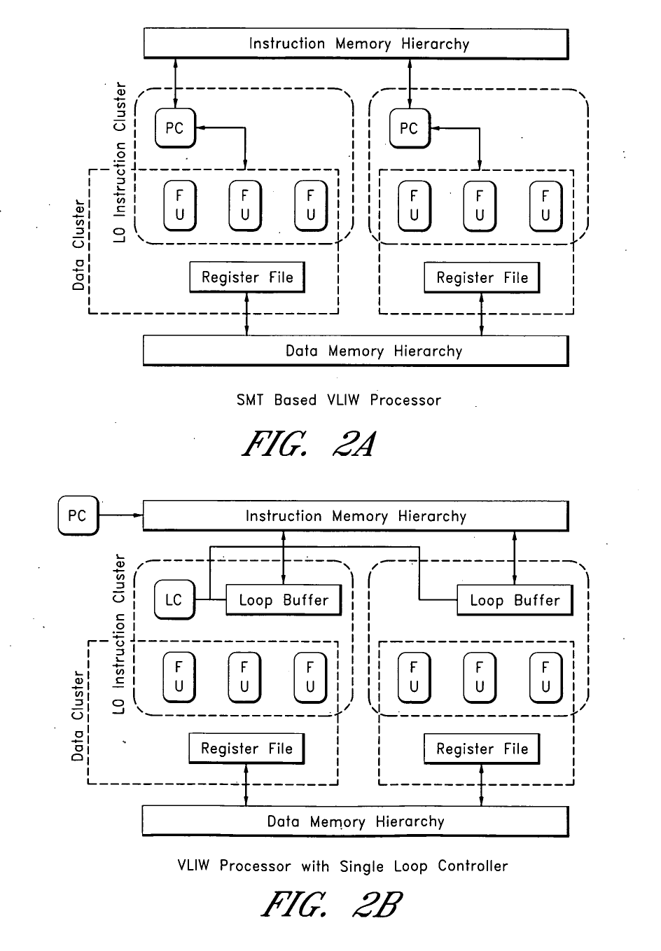

It has been shown by W. Dally, in “Low power architectures”, IEEE International Solid State Circuits Conference, Panel Talk on “When Processors Hit the Power Wall”, February 2005, that local interconnect is one of the growing problems for energy-aware design. It is therefore desired that the most frequently accessed instruction components for different clusters of the VLIW are located closer to their execution units. A distributed L0 buffer configuration for each VLIW cluster with separate loop controllers as shown in FIG. 2(c) can significantly reduce the energy consumed in the most active local wiring.

From the above discussions, it can be summarized that the instruction memory for a low power embedded processor preferably satisfies one or more of the following characteristics to be low power:
Smaller memories (loop buffer) instead of large instruction memory.
Distributed and localized instruction memories to reduce long interconnect and minimized interconnect switching on very active connections.
Specialized local controllers with minimal hardware overhead.
Distributed local controllers that can support execution of different loop organizations in parallel (single loops, multiple compatible loops and multiple incompatible loops).

One embodiment provides a multi-threaded distributed instruction memory hierarchy that can support execution of multiple incompatible loops (as illustrated in FIG. 1) in parallel. In addition to regular loops, irregular loops with conditional constructs and nested loops can also be mapped. Sub-routines and function calls within the loops must be selectively inlined or optimized using other loop transformations like code hoisting or loop splitting, to fit in the loop buffers. Alternatively, sub-routines could be executed from level-1 cache if they do not fit in the loop buffers.

A generic schematic of an architecture in accordance with embodiments of the present invention is shown in FIG. 2(c). The architecture has a multicluster datapath comprising an array of data clusters. Each data cluster comprises at least one functional unit and a register file. The register files are thus distributed over the multicluster data path. The architecture also has a multicluster instruction path comprising an array of instruction clusters, there being a one-to-one relationship between the data clusters and the instruction clusters. Each instruction cluster comprises at least one functional unit (the at least one functional unit of the corresponding data cluster) and a loop buffer of the instruction memory hierarchy. This way, a loop buffer is assigned to each instruction cluster, and thus to the corresponding data cluster. The instruction memory hierarchy thus comprises clustered loop buffers, and in accordance with embodiments of the present invention, each loop buffer has its own local controller, and each local controller is responsible for indexing and regulating accesses to its loop buffer. The novelties of the architecture enhancement in accordance with embodiments of the present invention are one or more of the following:
an energy-efficient and scalable, distributed controller organization
multi-threaded incompatible loop operation in uni-threaded processors is enabled, and
overall energy savings are obtained along with enhancement in performance.

In the architecture in accordance with embodiments of the present invention (FIG. 2(c), and detailed below), multiple loops can be executed in parallel, without the overhead/limitations mentioned above. Multiple synchronizable Loop Controllers (LCs) enable the execution of multiple loops in parallel as each loop has its own loop controller. However, the LC logic is simplified and the hardware overhead is minimal as it has to execute only loop code. Data sharing and synchronization is done at the register file level and therefore context switching and management costs are eliminated.

It is an advantage of embodiments of the present invention to have non-shared distributed resources. It is often the case in embedded systems that the same processor needs to run different processes with different characteristics. Recently there has been a strong academic as well as industrial trend towards application-specific units to reduce the energy consumed for performing a specific task. Each distributed instruction cluster can be considered as an application specific cluster. A distributed instruction cluster processor with its own loop buffer and minimized resource sharing, as in A. El-Moursy, R. Garg, D. Albonesi, and S. Dwarkadas, “Partitioning multi-threaded processors with a large number of threads.”, International Symposium on Performance Analysis of Systems and Software, March 2005, considerably reduces the extra energy cost due to the routing and interconnect requirement as it can be placed physically closer to its cluster.

It has been shown in W. Dally, “Low power architectures.”, IEEE International Solid State Circuits Conference, Panel Talk on “When Processors Hit the Power Wall”, February 2005 that local interconnect is one of the growing problems for energy-aware design. It is therefore an advantage if the instruction memories for different clusters of the processor are closer to their execution units. A distributed L0 loop buffer configuration for each cluster with separate loop controllers as shown in FIG. 2(c), can significantly reduce the energy consumed in the local wiring.

Hereinafter, details are presented of embodiments of the architecture in accordance with embodiments of the present invention, which embodiments save energy consumption and improve performance by enabling a synchronized multi-threaded operation in a uni-processor platform, i.e. in processors with single thread of control.

### Extending a Uni-Processor to Support Execution of Multiple Threads

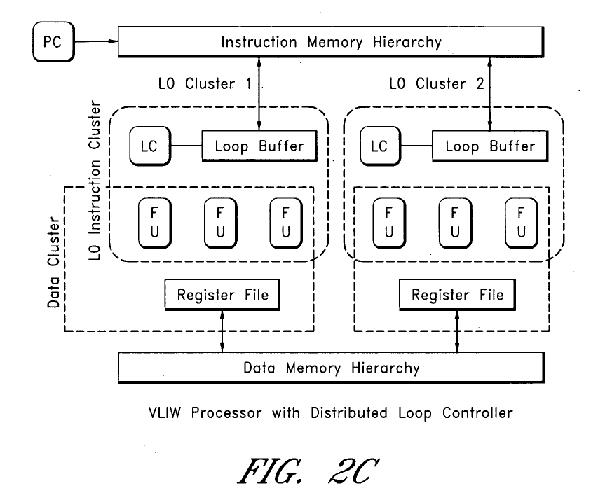

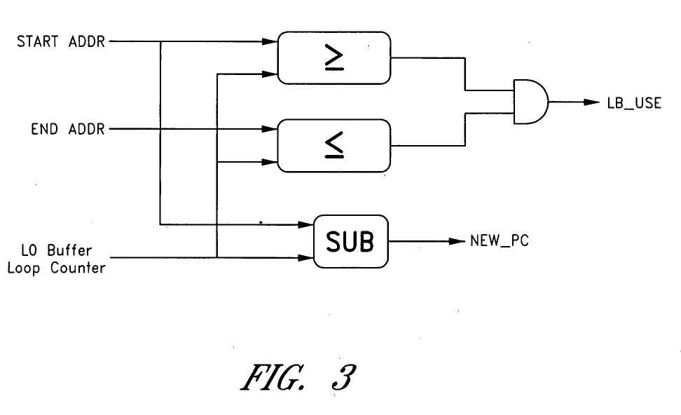

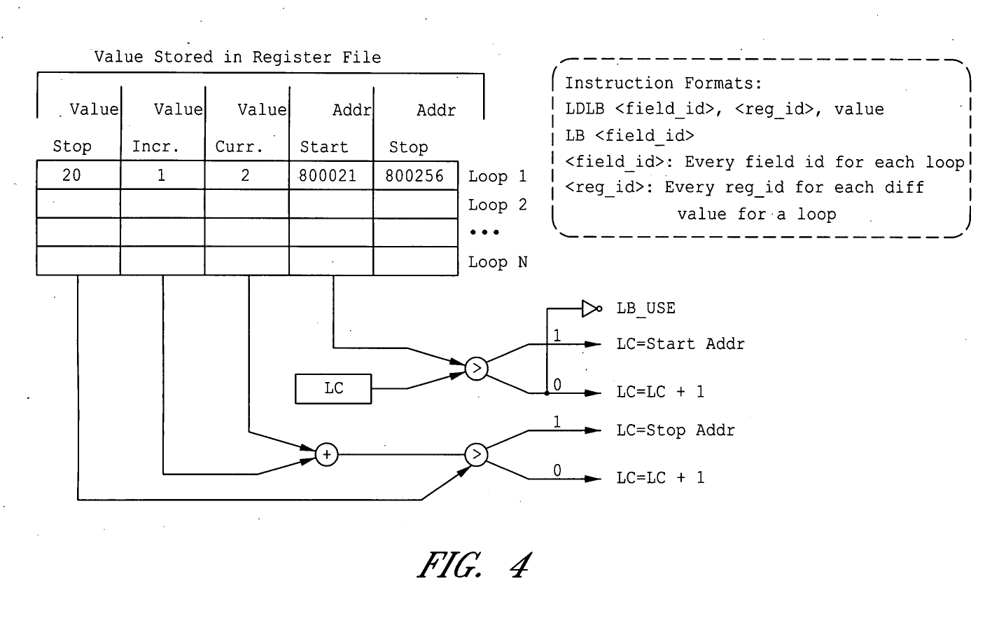

It is proposed to extend a uni-processor model to support two modes of loop buffer operation: Single-threaded and Multi-threaded. The extension to multi-threaded mode is done with special concern to support L0 buffer operation. A VLIW instruction is divided into bundles, where each bundle corresponds to an L0 cluster. Two basic architectures are described for the loop counter: a software counter based loop controller (shown in FIG. 3) and a hardware loop counter based architecture (shown in FIG. 4).

Software Counter Based Loop Controller

An L0 controller (illustrated in FIG. 3) along with a counter (e.g. 5 bits) is responsible for indexing and regulating accesses to the L0 buffer. Unlike conventional Program Counters (PCs), the controller logic is much smaller and consumes lower energy, with the loss in flexibility that only loops can be executed from the loop buffers. In other words, the PC can address complete address space of the instruction memory hierarchy, the L0 controller in accordance with embodiments of the present invention can access only the address space of the loop buffer. The LB_USE signal indicates execution of an instruction inside the L0 buffer. The NEW_PC signal is used to index into the L0 buffer.

The loop buffer operation is initiated on encountering the LBON instruction, as mentioned in Murali Jayapala, Francisco Barat, Tom Vander Aa, Francky Catthoor, Henk Corporaal, and Geert Deconinck, “Clustered loop buffer organization for low energy VLIW embedded processors”, IEEE Transactions on Computers, 54(6):672-683, June 2005. It is possible to perform branches inside the loop buffer as there is a path from the loop controller to the branch unit similar that the one presented in the above Jayapala document. It can be noticed that in spite of using a 5-bit LC, there is still a need to have instructions which at the end or start of the loop perform, increment, compare and conditional branch on the loop iterator values (similar to a regular set of instructions used for performing the loop). This can be eliminated using a hardware based counter in accordance with another embodiment of the present invention. For further details on the loop controller operation the reader is referred to the above Jayapala document, which is incorporated herein by reference.

Hardware Counter Based Loop Controller

FIG. 4 shows an illustration of a hardware loop based architecture. It is to be noted that this is still a fully programmable architecture. The standard register file contains the following: start value, stop value, increment value of the iterator, start and stop address for each of the different loops. The current iterator value is also stored in a separate register/counter LC as shown in FIG. 4. Based on these values, every time the loop is executed, the corresponding checks are made and necessary logic is activated.

FIG. 5 shows a sample C code and the corresponding assembly code which may be used for operating on this hardware based loop controller. The LDLB instructions are used to load the start, stop, increment values of the iterators, and start, stop address of the loop respectively in the register file. The format for the LDLB instruction is shown in FIG. 4. It can be seen from FIG. 5(b) that although a number of load operations (LDLB instructions) are needed to begin the loop mode (introducing an initial performance penalty), only one instruction (LB instruction) is needed while operating in the loop mode (LB 1 and LB 2). The loop buffer operation is started on encountering the LBON instruction, which demarcates the loop mode. The LB instructions activate the hardware shown in FIG. 4, thereby performing the iterator increment/decrement, comparison operations for the loop and branching to the appropriate location if necessary. Hence the instruction memory cost (number of accesses to the loop buffer) for every loop is reduced, although the operations performed are the same.

At the beginning of the loop nest, the corresponding, start, stop, increment values of the loop iterator and the start and stop address of the corresponding loop must be initialized. These values reside in the register file. Although a separate register file for these values could be imagined for optimizing the power further, these values are best kept in the standard register file, as they may be used for other address computation inside the loop. Such a configuration also enables possible conditional branches within the loop buffer as well as to outside the loop buffer. The initialization values for each loop can be optionally from other registers. This allows the loop bounds to be non-affine. Non-affine implies that the initialization values are not known at compile time. It is possible to have both conditions inside the loop buffer mode as well as breaks outside the loop buffer code.

Similar to the software based loop counter the signal LB USE is generated for every loop indicating the loop buffer is in use. This signal is used later on for multi-threading.

Since a hardware counter is used instead of the regular datapath, the counter size can be customized to be of the size of the largest iterator value that may be used in the application, which usually is much lower than the 32-bit integers. Since the data for loop counters are stored in the register file itself, there is no restriction on the depth of the loop nest that can be handled, unlike other processors like StarCore, SC140 DSP Core Reference Manual, June 2000, and TI C64x+series.

Running Multiple Loops in Parallel

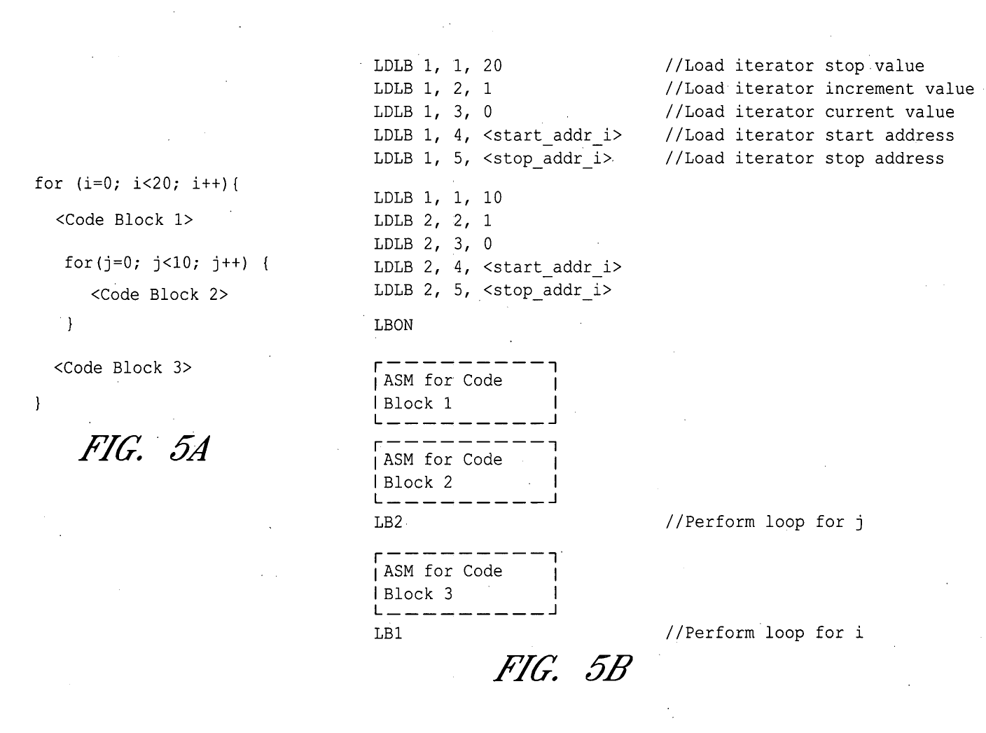

The L0 controllers can be seamlessly operated in single/multi-threaded mode. The multi-threaded mode of operation for both the software controlled loop buffer and hardware controlled loop buffer is similar as both of them produce the same signals (LB USE) and use LBON for starting the L0 operation. The state diagram of the L0 Buffer operation is shown in FIG. 6. The single threaded loop buffer operation is initiated on encountering the LBON <addr> <offset> instruction. Here <addr> denotes the start address of the loop's first instruction and <offset> denotes the number of instructions to be fetched to the loop buffer starting from address <addr>. In the single threaded mode, the loop counter of each cluster may be incremented in lock-step every cycle. This mode of operation is similar to the L0 buffer operation presented in M. Jaypala, T. Vanderaa, et. al., “Clustered Loop Buffer Organization for Low Energy VLIW Embedded Processors”, IEEE Transactions on VLSI, June 2004, but in the approach in accordance with embodiments of the present invention an entire cluster can be made inactive for a given loop nest to save energy. In case of the hardware based loop buffer operation the LDLB and LB instructions are also needed for the single threaded operation as explained above.

In the multi-threaded mode, the loop counters are still incremented in lock-step under a same timing signal, e.g. a same clock, but not necessarily at every instruction. Instead they align or synchronize at loop boundaries or explicit alignment or synchronization points identified by the compiler (explained below). To spawn execution of multiple loops that have to be executed in parallel, each L0 cluster is provided with a separate instruction (LDLCi <addr> <offset>) to explicitly load different loops into the corresponding L0 clusters. Here i denotes the cluster number. For instance, in the following example two instructions LDLC1 <addr1> <offset1> and LDLC2<addr2> <offset2> are inserted in the code to indicate that the loop at addr1 is to be executed in cluster 1 and the loop at the addr2 is to be executed in cluster 2.

. . .

| | |
|---|---|
| | LDLC1 <addr1> <offset1> |
| | LDLC2 <addr2> <offset2> |
| addr1: | for (. . .){ |
| | Loop Body } |
| addr2: | for (. . .){ |
| | Loop Body } |

. . .

Once the instruction LDLCi is encountered, the processor operates in the multi-threading mode. During the initialization phase all the active loop buffers are loaded with the code that they will be running. For example, the ith loop buffer will be loaded with offseti number of instructions starting from address addri specified in instruction LDLCi. Meanwhile, each cluster's loop controller copies the needed instructions from the instruction memory into the corresponding loop buffer. If not all the clusters are used for executing multiple loops, then explicit instructions are inserted by the compiler to disable them. The LDLCi instructions are used the same way and instead of the LBON instruction for both the software and hardware controlled loop buffer architectures. For the above example, in case of the hardware based loop buffer architecture, the LDLB instructions for initializing the loop interations and address for the two loops would precede the LDLC instructions.

When a cluster has completed fetching a set of instructions from its corresponding address, the loop buffer enters the execution stage of the Multi-threaded execution operation. During the execution stage, each loop execution is independent of the others. This independent execution of the different clusters can be either through the software loop counter or the hardware based loop controller mechanism. Although the loop iterators are not in lock-step, the different loop buffers are aligned or synchronized at specific alignment or synchronization points (where dependencies were not met) that are identified by the compiler. Additionally, the compiler or the programmer must ensure the data consistency or the necessary data transfers across the data clusters.

The loops loaded onto the different L0 clusters can have loop boundaries, loop iterators, loop increments etc. which are different from each other. This enables operating different incompatible loops in parallel to each other.

### Software/Compiler Support

The code generation for the architecture in accordance with embodiments of the present invention is similar to the code generated for a conventional VLIW processor, except for the parts of the code that need to be executed in multi-threaded mode. As mentioned above, additional instructions are inserted to initiate the multi-threaded mode of operation.

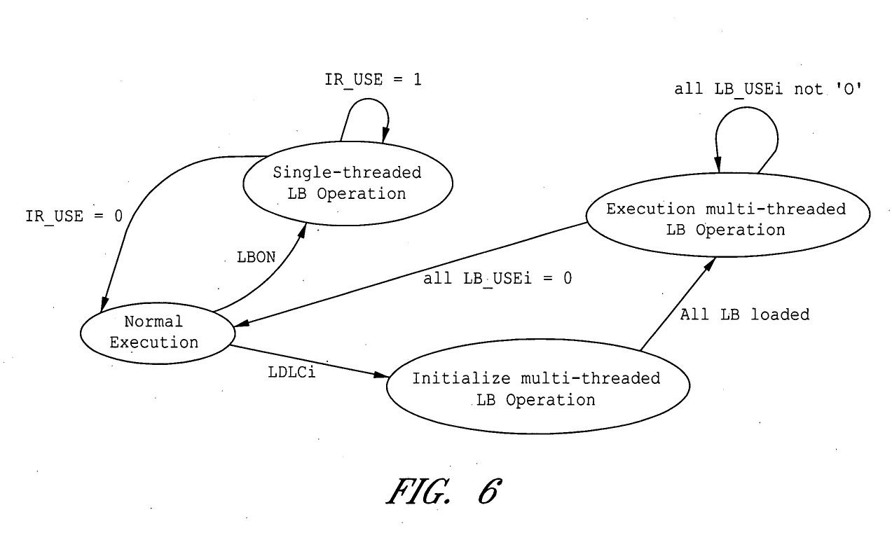

FIG. 7 shows the assembly code for the two incompatible loops presented in FIG. 1. Code 1 is loaded to L0 Cluster 1 and Code 2 is loaded to L0 Cluster 2. If, for two iterations of loop i, only one iteration of loop i′ has to be executed, then there is a need to identify this dependency and need to insert necessary alignment or synchronization points to respect this dependency. The compiler needs to extract and analyze data dependencies between these two loops. For this purpose, the two loops shown in FIG. 1 are first represented in a polyhedral model, as described in F. Quillere, S. Rajopadhye, and D. Wilde, “Generation of efficient nested loops from polyhedra”, Intl. Journal on Parallel Programming, 2000. Once the different codes are represented in a common iteration domain, as described in the Quillere document, a data dependency analysis can be done, as described in J. I. Gömez, P. Marchal, et. al., “Optimizing the memory bandwidth with loop morphing”, ASAP, pages 213-223, 2004. On analyzing the data dependencies between different codes, the alignment or synchronization points can be derived. The alignment or synchronization points are then annotated back on the original code shown in FIG. 7 within brackets. In case the original code has pointers or if conditions are met which prevent from entering the polyhedral model, various pre-processing techniques may be used, like e.g. SSA, if-conversion, pointer removal as described in Martin Palkovic, Erik Brockmeyer, Peter Vanbroekhoven, Henk Corporaal, and Francky Catthoor, “Systematic pre-processing of data dependent constructs for embedded systems”, Proceedings of PATMOS, pages 89-98, 2005.

Alignment or synchronization of iterators between the two clusters is achieved by adding extra information, e.g. an extra bit, to every instruction. An example of such extra bits is shown in FIG. 7. A ‘0’ means that the instruction can be executed independently of the other cluster and a ‘1’ means that the instruction can only be executed if the other cluster issues a ‘1’ as well. In the example shown in FIG. 7, the only one extra bit is sufficient as there are only two instruction clusters. In case of more than two instruction clusters, one bit can be used for every other cluster that needs to be aligned or synchronized with. The handshaking/instruction level synchronization can, however, be implemented in multiple ways. For example, instruction ld c1, 0 of both the clusters would be issued simultaneously. Worst-case the number of bits required for synchronization is one less than the number of clusters. A trade-off can be made between granularity of alignment or synchronization versus the overhead due to alignment or synchronization. If necessary extra nop instructions may be inserted to obtain correct synchronization. This instruction level synchronization reduces the number of accesses to the instruction memory and hence is energy-efficient.

It can be seen from the assembly code in FIG. 7 that using the synchronization bits the data sharing can be done at the register level instead of the cache level like in the case of SMT processors. This reduces the number of reads and writes to the memory and register file and further saving energy.

### Experimental Platform Setup

Experiments were performed on a CRISP simulator as described by P. OpDeBeeck, F. Barat, et. Al, in “CRISP: A template for reconfigurable instruction set processors”, Proc of International conference on Field Programmable Logic (FPL), August 2001. The CRISP simulator is built on the Trimaran VLIW frame-work as described in “Trimaran: An Infrastructure for Research in Instruction-Level Parallelism.”. The simulator was annotated with power models for different parts of the system. The power models for the different parts of the processor where obtained using Synopsys Physical Compiler and Design Ware components, TSMC90 nm technology, 1.0V Vdd. The power was computed after complete layout was performed and was back-annotated with activity reported by simulation using ModelSim. The complete system was clocked at 200 MHz (which can be considered roughly to be the clock frequency of most embedded systems, nevertheless the results are also valid for other operating frequencies). The extra energy consumed due to the synchronization hardware was also estimated using Physical Compiler after layout, capacitance extraction and back-annotation. Memories from Artisan Memory Generator were used. These different blocks were then placed and routed, and the energy consumption of the interconnect between the different components was calculated based on the activation of the different components. The experimental setup and flow is shown in FIG. 8. The interconnect requirement between the loop buffers, loop controller and the functional units is also taken into account while computing the energy estimates.

Special instructions as mentioned above were inserted to enable multi-threaded operation on the VLIW. The experiments were performed on a VLIW with four slots. All slots were considered to be homogeneous and form one data cluster i.e. all four slots share the same global register file. Two slots are grouped into one L0 instruction cluster. Hence the VLIW processor has one common data cluster and two L0 instruction clusters. Since most current embedded applications do not provide very high ILP, a VLIW of 4 slots was chosen. Although the multi-threading technique in accordance with embodiments of the present invention is applied on a 4 issue VLIW, the results scale to other sizes of VLIWs provided the application also provides the required ILP. In case more threads are used (greater than 2), a wider VLIW can be used.

### Benchmarks and Base Architectures Used

The TI DSP benchmarks are used for benchmarking the multi-threading architecture in accordance with embodiments of the present invention, which is a representative set for the embedded systems domain. The output of the first benchmark is assumed to be the input to the second benchmark. This is done to create an artificial dependency between the two threads. Experiments are also performed on real kernels from a Software Defined Radio (SDR) design of a MIMO WLAN receiver (2-antenna OFDM based outputs). After profiling, the blocks that contribute most to the overall computational requirement were taken (viz. Channel Estimation kernels, Channel Compensation—It is to be noted that BPSK FFT was the highest consumer, but it is not used as it was fully optimized at the assembly level and mapped on a separate hardware accelerator). In these cases, dependencies exist across different blocks and they can be executed in two clusters.

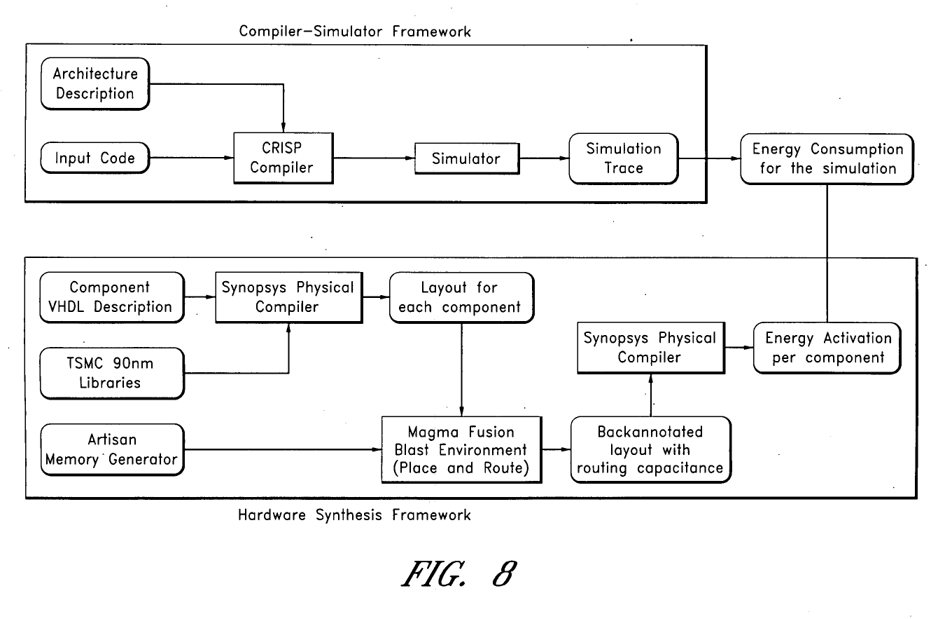

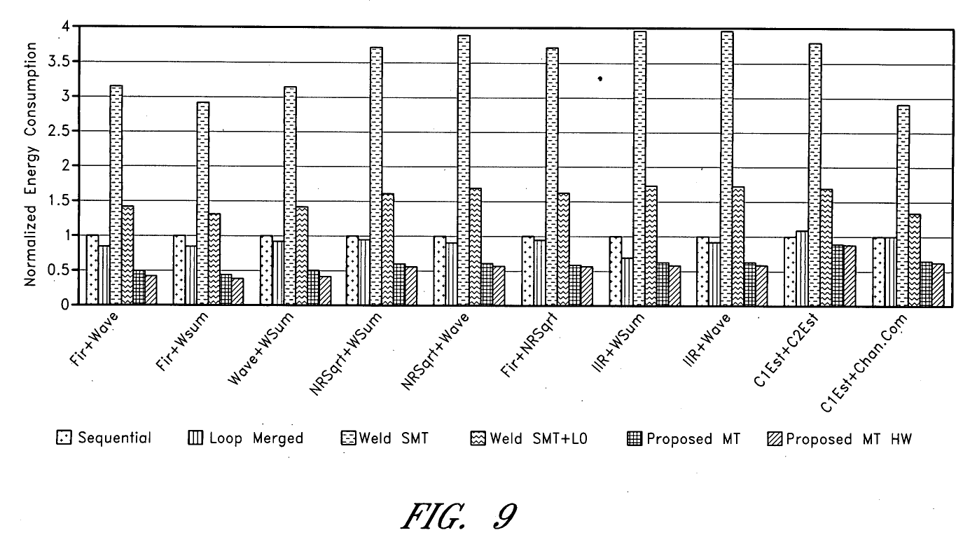

FIGS. 9 and 10, respectively, show the energy savings and performance gains that can be obtained when multiple kernels are run on different L0 instruction clusters of the VLIW processor with the multi-threading extension in accordance with embodiments of the present invention. The energy savings are considered for the instruction memories of the processor as they are one of the dominant part of any programmable platform SoC, see Andy Lambrechts, Praveen Raghavan, Anthony Leroy, Guillermo Talayera, Tom Van der Aa, Murali Jayapala, Francky Catthoor, Diederik Verkest, Geert Deconinck, Henk Coporaal, Frederic Robert, and Jordi Carrabina, “Power breakdown analysis for a heterogeneous NoC platform running a video application”, Proc of IEEE 16th International Conference on Application-specific Systems, Architectures and Processors (ASAP), pages 179-184, July 2005.

In the Sequential case (Baseline case), two different codes are executed on the VLIW one after the other. The VLIW has a centralized loop buffer organization. In the loop merged case, a variant of the loop fusion technique described in Jose Ignacio Gómez, Paul Marchal, Sven Verdoorlaege, Luis Pifiuel, and Francky Catthoor, “Optimizing the memory bandwidth with loop morphing”, ASAP, pages 213-223, 2004, is applied and executed on the VLIW with a centralized loop buffer organization and with a central loop controller. For the Weld SMT case, a complete program counter and instruction memory of 32 KB are used. The SMT is performed as described in E. Ozer, T. M. Conte, and S. Sharma. “Weld: A multithreading technique towards latency-tolerant VLIW processors”, International Conference on High Performance Computing, 2001. This SMT has also been enhanced with an energy efficient centralized loop buffer instead of the IL1 and PC based architecture. The overhead of the “Welder” is also taken into account. The “Welder” is a network constructed of muxes and a mux controller, to distribute operations for different threads over the functional unit. Although SMT and Loop buffer technique are orthogonal, for the comparison to be fair the loop buffering technique has also been applied to the SMT architecture (Weld SMT+L0).

The software based multi-threading in accordance with an embodiment of the present invention (Proposed MT) is based on the logic shown in FIG. 3. The hardware loop counter based multi-threading according to another embodiment of the present invention (Proposed MT HW) is based on the logic shown in FIG. 4. This architecture has a 5-bit loop counter logic for each cluster. All the results are normalized with respect to the sequential execution. Also aggressive compiler optimizations like software pipelining, loop unrolling etc. have been applied in all the different cases.

### Energy and Performance Analysis

The Loop-Merged(Morphed) technique saves both performance and energy over the Sequential technique (see FIGS. 10 and 9) since extra memory accesses are not required and data sharing is performed at the register file level. Therefore the Loop-Merged technique is more energy as well as performance efficient compared to the Sequential case. In case of the Loop-Merged case there exists an overhead due to iterator boundaries etc., which introduce extra control instructions.

The Weld SMT and Weld SMT+L0 improve the performance further as both tasks are performed simultaneously. In some benchmarks used, the Weld SMT can help achieve an IPC which is close to 4. The overhead due to the “Welder” is quite large and hence in terms of energy the Weld based techniques perform worse than both the sequential and the loop merged case. Also since the “Welder” has to be activated at every issue cycle, its activity is also quite high. Additionally, an extra overhead is present for maintaining two PCs (in case of Weld SMT) or two LCs (in case of Weld SMT+L0) for running two threads in parallel. The data sharing is at the level of the DL1, therefore an added communication overhead exists. As a result, the Weld based techniques perform worse than the sequential and the loop merged techniques in terms of energy. Even if enhancements like sharing data at the register file level are introduced, the overhead due to the Weld logic and maintenance of two PCs is large for embedded systems.

In case of the Proposed MT and Proposed MT HW architectures in accordance with embodiments of the present invention, the tasks are performed simultaneously like in the case of Weld SMT, but the data sharing is at the register-level. This explains the energy and performance gains over the Sequential and Loop Merged cases. Since the overhead of the “Welder” is not present, the energy gains over the Weld SMT+L0 technique is large as well. Further gains are obtained due to the reduced logic requirement for the loop controllers and the distributed loop buffers. In conclusion, the technique in accordance with embodiments of the present invention has the advantages of both loop-merging as well as SMT and avoids the pit-falls of both these techniques.

The results show that the Proposed MT in accordance with an embodiment of the present invention has an energy saving of 40% over sequential, 34% over advanced loop merged and 59% over the enhanced SMT (Weld SMT+L0) technique. On average the Proposed MT in accordance with an embodiment of the present invention has a performance gain of 40% over sequential, 27% over loop merged and 22% over Weld SMT techniques. In certain cases like Chan1Est+Chan2Est and C1Est+ChanCompen, the SMT based techniques outperform the multithreading in accordance with embodiments of the present invention as the amount of data sharing is very low compared to the size of the benchmark. In terms of energy consumption the multi-threading in accordance with embodiments of the present invention is always better than other techniques. It can be intuitively seen that in case the Weld SMT+L0 architecture is further enhanced with data sharing at the register file level, the Proposed MT and Proposed MT HW in accordance with embodiments of the present invention would perform relatively worse in terms of performance. In terms of energy efficiency however, the Proposed MT and Proposed MT HW based architectures in accordance with embodiments of the present invention would still be much better. It has been theoretically observed (this implies removing the cycles that correspond to the shared data transfer through the memory) that even when the Weld SMT+L0 architecture would support data sharing at the register file level, the performance gain of this architecture over the Proposed MT and Proposed MT HW in accordance with embodiments of the present invention is less than 5% in most cases.

The Proposed MT HW in accordance with an embodiment of the present invention is both more energy efficient as well as has better performance compared to the Proposed MT technique in accordance with another embodiment of the present invention. This is more apparent in smaller benchmarks as the number of instructions per loop iteration is small. The hardware based loop counter (Proposed MT HW) outperforms the software based technique, as the number of cycles required for performing the loop branches and iterator computation is reduced. This difference is larger in case of smaller benchmarks and smaller in case of larger benchmarks. Also in terms of energy efficiency the Proposed MT HW is more energy efficient compared to the Proposed MT. The overhead of loading the loop iterators and the values required form the Proposed MT HW architecture was about 2-3 cycles for every loop nest. This overhead depends on the depth of the loop nest. Since all the LDLB instructions are independent of each other, they can be executed in parallel. Since in almost all cases, the cycles required for the loop body multiplied by the loop iterations is quite large, the extra overhead of initialization of the hardware counter is small. The synchronization required between the distributed loop buffers in case of both the Proposed MT and Proposed MT HW, was of the order of 1-2 cycles per loop iteration for most benchmarks. The relative overhead of this synchronization depends on the number of cycles required for the loop body itself and the amount of data sharing present across the two loops running in parallel. For example, the loop body size of the benchmark Chan1Est+Chan2Est is about 163 cycles and 6 cycles of this were due to synchronization.

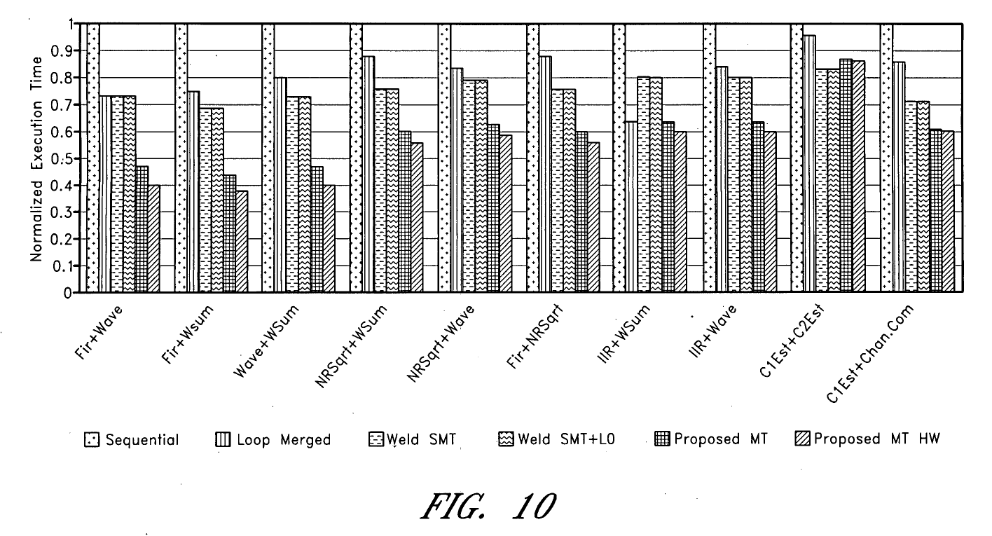

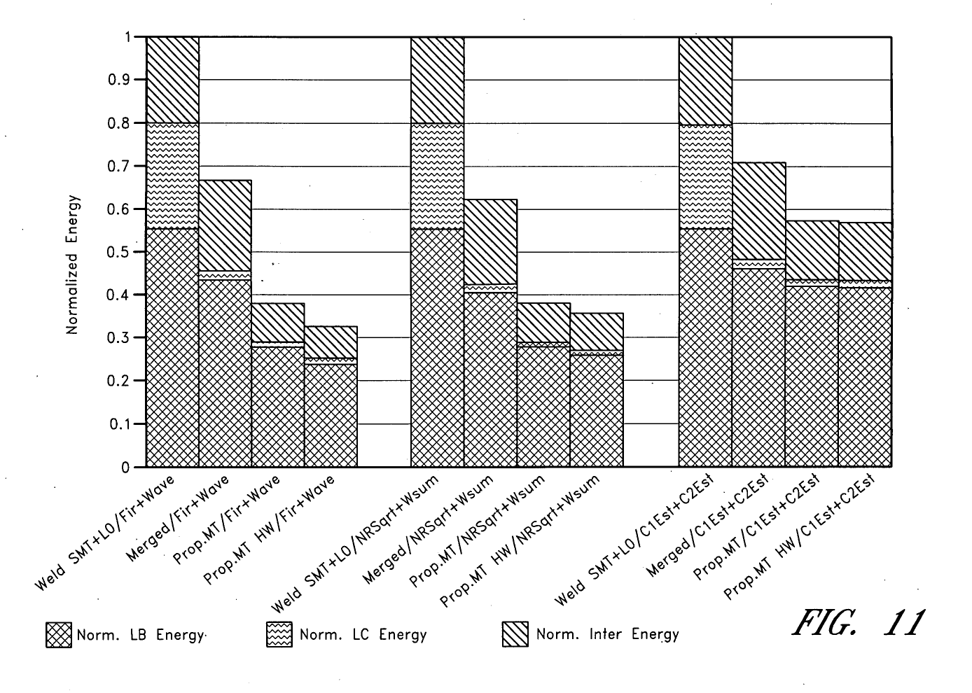

To further analyze the energy efficiency of these various architectures, the energy consumption in different parts of the instruction memory is split for three of the benchmarks and is shown in FIG. 11. The energy consumption is split into three parts and is normalized to the Weld SMT+L0 energy consumption:
1. LB Energy: Energy consumption of the loop buffer which stores the loop instructions
2. LC Energy: Energy consumption of the control logic required for accessing the instruction (Loop Controller, Weld logic, Hardware loop counter etc.)
3. Interconnect Energy: Energy consumption of the interconnect between the loop buffer and the FUs

FIG. 11 shows that the energy consumption of the LC logic considerably reduces as we move from the Weld SMT+L0 based architecture to a standard L0 based architecture with a single LC or the Proposed MT and Proposed MT HW based architectures in accordance with embodiments of the present invention. This is because the overhead of the Weld logic, extra cost of maintaining two loop controllers. The interconnect cost also reduces as we go from a centralized loop buffer based architecture to a distributed loop buffer based architecture by almost a factor of 20%. In case of smaller loops the energy efficiency of the Proposed MT HW is higher than that of the Proposed MT.

Embodiments of the present invention thus present an architecture which reduces the energy consumed in the instruction memory hierarchy and improves performance. The distributed instruction memory organization of embodiments of the present invention enables multi-threaded operation of loops in a uni-threaded processor platform. The hardware overhead required is shown to be minimal. An average energy saving of 59% was demonstrated in the instruction memory hierarchy over state of the art SMT techniques along with a performance gain of 22%. The architecture in accordance with embodiments of the present invention is shown to handle data dependencies across the multiple threads. The architectures in accordance with embodiments of the present invention have low interconnect overhead and hence are suitable for technology scaling.

### Layout Optimization

Layout optimization also helps in obtaining a low power processor architecture design. Therefore, embodiments of the present invention also involve a cross-abstraction optimization strategy that propagates the constraints from the layout till the instruction set and compiler of a processor. Details of an example of a processor for which the layout optimization of embodiments of the present invention can be used can be found in EP-05447054.7.

Low power design is one of the most important drivers of most embedded system markets. As Vdd scaling across technologies has been slowing down, it has become extremely important to perform cross-abstraction optimization.

FIG. 12 shows the energy split between the energy required to driving interconnect and transistors (logic) as technology scales. It shows 230K cells connected to for certain logic and the corresponding energy consumption as technology scales. It can be clearly inferred from FIG. 12 that interconnect is the most dominant part of the energy consumption.

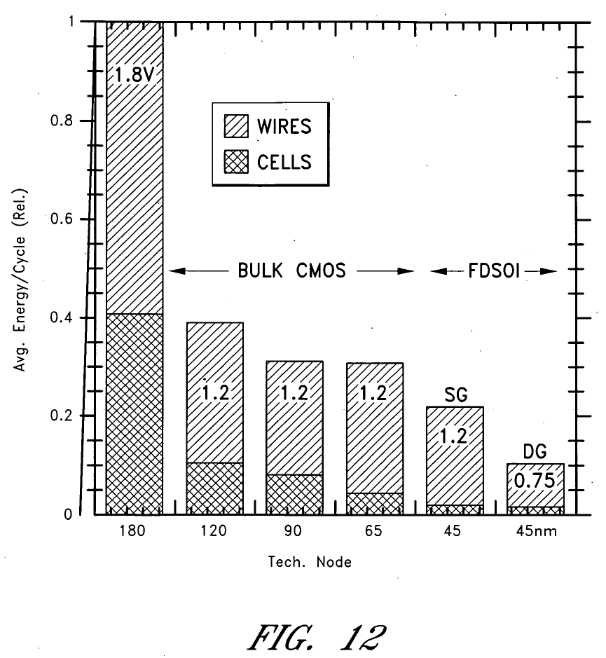

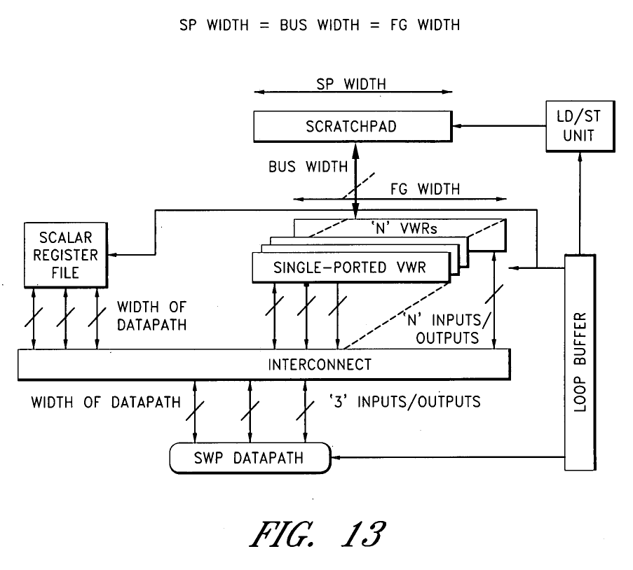

FIG. 13 shows an example of an architecture as described in EP-05447054.7, incorporated herein by reference, and for which the layout optimization of embodiments of the present invention can be used. A brief description of this architecture is presented below.

The architecture of EP-05447054.7 comprises a wide memory unit that is software controlled. A wide bus connects this memory to a set of very wide registers (VWR). Each VWR, contain a set of registers which can hold multiple words. Each register cell in the VWR is single ported and hence consumes low power. The width of the VWR is equal to that of the bus width and that of a line of the software controlled wide memory unit. The VWR has a second interface to the datapath (functional units). Since the register cells in the VWR are single ported, the VWRs are connected to the datapath using a muxing/demuxing structure.

Since the VWR are as wide as the memory and the buses between the memory unit and the VWR are also as wide, a large optimization can be performed to reduce the energy consumption of the interconnect (by reducing its capacitance).

### Design Procedure/Optimization

A flow or technique to optimize aspect ratio and pin placement of different modules in a design is explained hereinafter, with reference to FIG. 14.

The Aspect Ratio (AR) and Pin Position (PP) optimization procedure in accordance with embodiments of the present invention can be split up into two phases: Phase-1 and Phase-2. The different processes involved in the two phases are described below and are also shown in the flow diagram. To complete the full Physical Design, Phase-3 can also be used (which performs floor planning, placement and route between the different modules). Phase-3 is outside the scope of one embodiment.

Phase-1:

From the top level design, a hierarchical split between the different components of the processor (for e.g. Register File, Datapath clusters, Instruction Buffers/Loop Buffers, Data memory, DMA datapath, Instruction Memory) can be made. This split is design dependent and can be made manually or automated.

The different “partitioned” components are from here on referred to as modules. Once partitioned, the aspect ratio (AR) of the modules and the pin placement of the different pins of each module need to be decided after which a floor plan and place and route can be done.

The activity of the different modules and their connectivity to the other modules can be obtained via (RTL) simulation of the design under realistic conditions. Once the activity of the different modules and the activity of the connectivity between the different modules are known (usually captured with the SAIF format either at Gate or RTL level) an estimate of the energy consumption of the module can be taken, as changing the Aspect Ratio and pin position impacts the energy consumption of both the module itself and the interconnect. It is to be noted that the energy estimation can be obtained from a gate level simulation of the complete processor (with all its modules), while running a realistic testbench.

Once a list of the different modules and their activity is known, a high level estimation of the energy consumption can be made and the list can be ordered e.g. based on a descending order of energy consumption. The estimate of the energy consumption of the component can be done with a default Aspect Ratio (AR) and a default pin placement (PP), which could be decided by a tool like Synopsys Physical Compiler (after logic and physical synthesis). An example of a descending list of energy consuming modules could be for example: Data Memory, Instruction Memory, Data Register File, Datapath, DMA, and Loop Buffer.

Phase-2:

Once a list of different modules and their energy consumption and the energy consumption of nets connecting the module is made, the aspect ratio and the pin placement of one of the highest energy consuming modules are first decided and then the constraints are passed on to a next module. For example, since the data memory is one of the highest energy consuming modules (based on activity and interconnect capacitance estimation), the pin positions and the optimal aspect ratio of this module may be decided first. The constraints found are then passed on to the register file. Next, based on the constraints of the data memory, the pin placement of the register file and its aspect ratio can be decided.

For example in case of the processor of EP-05447054.7, this would imply that the pitch of the sense amplifier of the data memory would impose a constraint on the pin position of the next block (VWR). Therefore the pitch of the sense amplifier would be the pitch of the flip-flops of the VWR. The aspect ratio of the block can then be adapted such that the energy consumption of the net between these two modules is minimized (Data memory and VWR). Next the pin positions of the register file/VWR would decide or determine the pin position of the datapath.

In a normal processor this would mean that the input ports of the register file which is used for Load/Store (between the register file and the data memory) would be located next to the memory's pins. Such an optimization would reduce the energy consumption of the net which connects the data memory to the register file.

While deciding on the AR and PP of a module under consideration, a relative placement of the modules which impose a constraint on this module under consideration has to be estimated such that the decisions of the AR and PP of the current module can be taken. During physical synthesis of the individual module, the pin position has to be kept flexible such that the AR and PP can be optimized.

It should be noted that after the change in AR and PP of each module, layout and placement of standard cells inside the module (physical synthesis) has to be redone and also the Place and Route of the standard cells inside the module has to be done. This can be done using a regular physical synthesis tool like Physical Compiler.

The next module in the ordered list of energy hungry modules could be the datapath. In such a case, this implies that the pin position of the datapath is imposed by the aspect ratio and pin position of the register file. Once the pin position of the datapath is decided upon, the aspect ratio of the datapath can be optimized such that the energy consumption of the nets between the register file/VWR and the datapath is minimized. Similarly, the aspect ratio and pin position of all the clusters of the datapath is to be decided. It is to be noted that the different data clusters of the processor could include the DMA, MMU and other units which also perform the data transfer. If these datapath elements (like DMA, LD/ST) are also connected to other units like the data memory, then constraints of the pin position and aspect ratio of the memory would be taken as constraints for these datapath elements as well.

The next unit where the aspect ratio and the pin position needs to be decided may be the instruction memory. The instruction memory can comprise different hierarchies e.g. loop buffers, L1 Instruction Memory etc. Once again, based on high level estimates, the highest energy consuming unit for e.g. the Loop Buffer has to be considered and then the higher levels of the memory.

Phase-3:

Once the AR and PP of each of the different modules are obtained, the activity information of the interconnection between the different modules can be used for performing an optimized floor planning, placement and routing, as described in EP-03447162.3. In this phase, the activity/energy consumption of the interconnection between the different modules has to be taken as input to drive the place and route.

Five designs of the processor as described in EP-05447054.7 have been made. The first design (Flat design) consisted of completely synthesizing the processor in a flat way by Synopsys Physical Compiler using TSMC 130 nm, 1.2V design technology. The processor comprised 3 VWRs and a datapath with loop buffers for the instruction storage. The width of the VWR was taken to be 768 bits. The size of the datapath (word size) was taken to be 96 bits. Therefore 8 words can be simultaneously stored in one VWR. The width of the wide bus, between the memory and the VWR was also taken to be 768 bits. The width of one wide memory line was also taken to be 768 bits.

Once the design of the processor core was completed in Physical Compiler, the design was then exported to the Magma Fusion Blast environment using the PDEF file-exchange format. A custom placement and route algorithm was used to route between the memory unit and the core. The complete flow of the technique used for power estimation is shown in FIG. 15. FIG. 15 also shows the different tools and the files used to interchange formats used across the different tools.

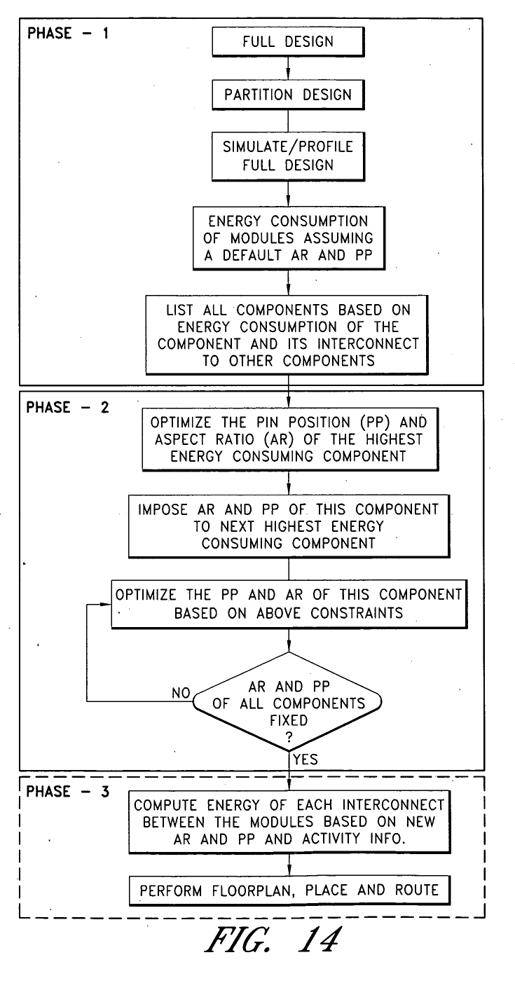

FIG. 16 shows the layout after place and route for the Flat Design. It can be seen directly from FIG. 16 that the routing the two components (Core and the memory) is very large and hence the flat design would result in very high energy consumption.

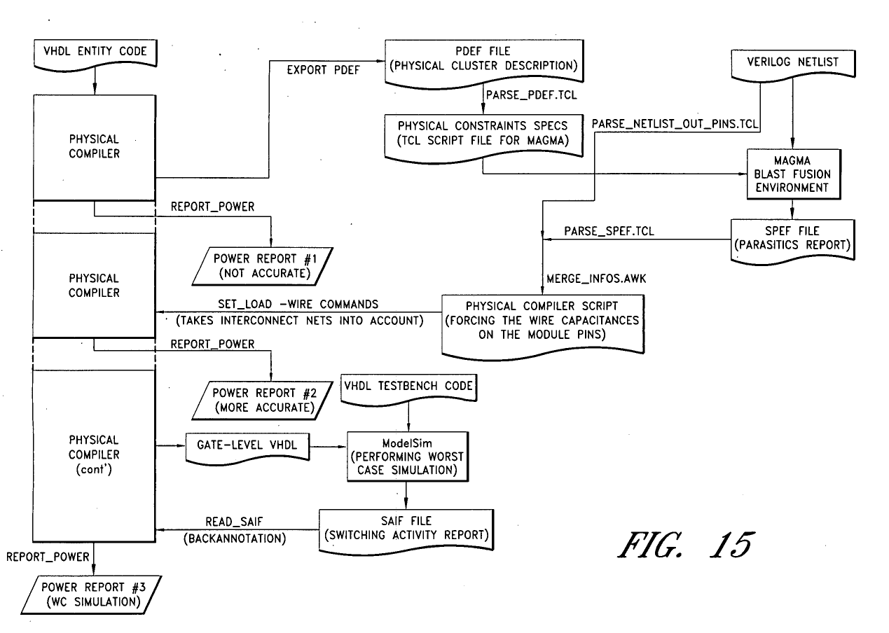

In a first optimization the different parts of the processor (very wide registers, datapath, loop buffers) were separately synthesized in Physical Compiler and then placed and routed in Magma Fusion Blast. The default shape (aspect ratio) and default pin placement was taken from Physical Compiler and routed in Magma. The design is henceforth referred to as “Default Shape and Default Pin” (DS_DP). The DS_DP design is shown in FIG. 17.

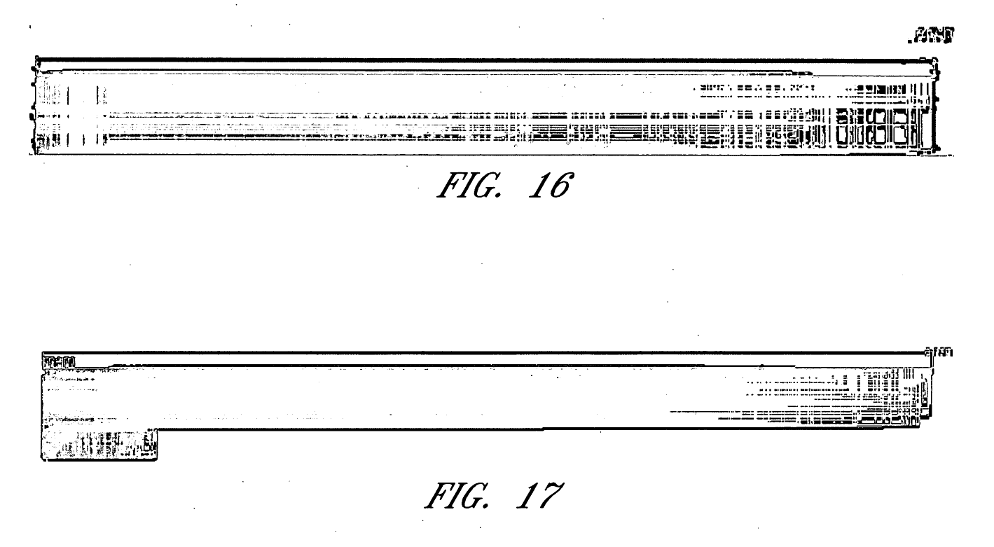

To optimize the design further, the different parts of the processor were shaped so that they could align perfectly with the other parts. The pins were still placed using the default options. This design is referred to as “Shaped and Default Pin Placement” (S_DP). This is shown in FIG. 18. It can once again be noted that the interconnect is a dominant part of the design. Such a S_DP design reduces the horizontal interconnect requirement but the vertical congestion remains.

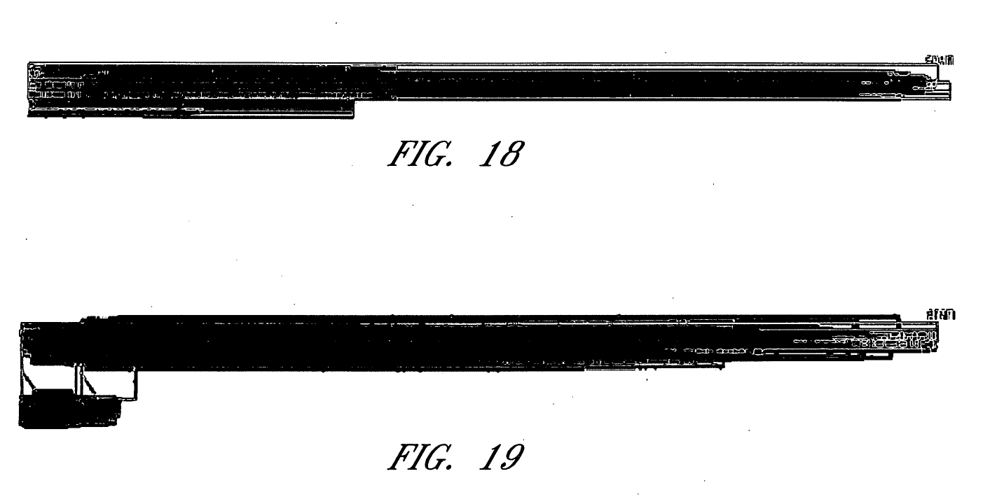

Another optimization was performed by using the pin placement appropriately and using the default shape (aspect ratio): “Pin Placement and Default Shape” (DS_PP). Although the vertical length of the interconnect is reduced, as the all the wires need to converge in a small location (due to square aspect ratio). Hence the horizontal interconnect/congestion is very large FIG. 19 shows the DS_PP design.

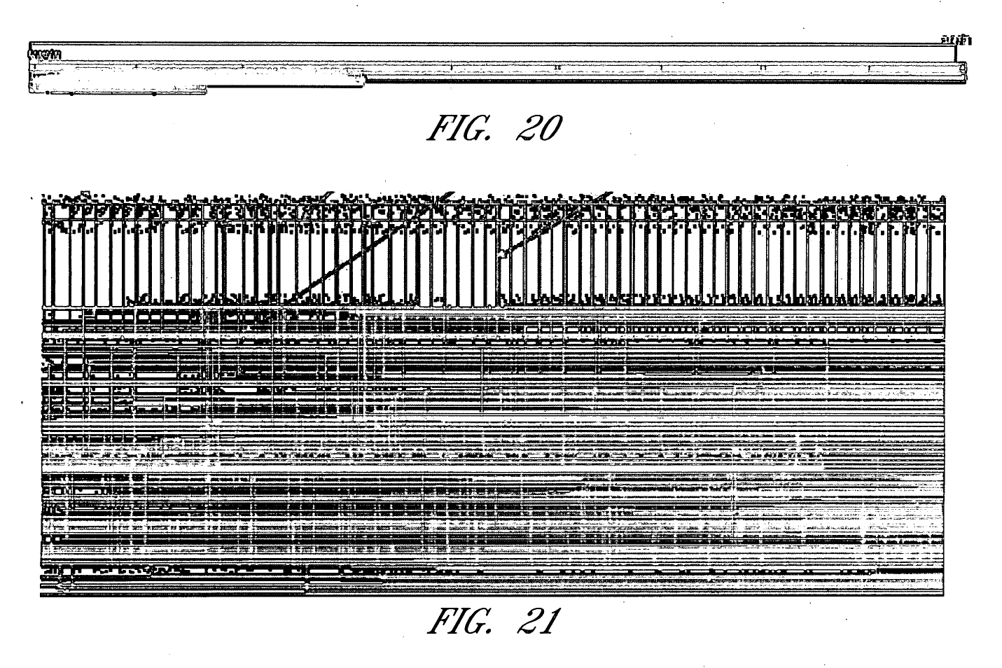

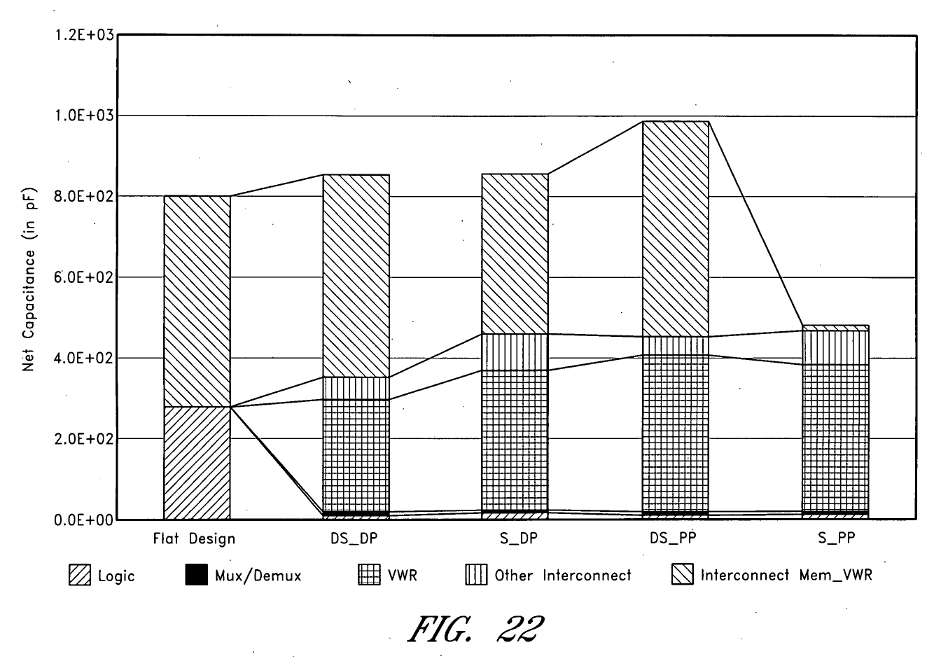

For the most optimal design, each module/component of the processor was shaped and pin placement was performed: “Shaped and Pin Placement” (S_PP). This design is shown in FIG. 20. As this helps both the vertical as well as horizontal interconnect congestion, the net interconnect lengths is reduced drastically. As a further optimization it was ensured that the pitch of the sense amplifiers (of the software controlled wide memory), were aligned to that of the pitch of the flip flops of the VWRs. Therefore reducing the interconnect between the two units dramatically. A zoomed in view of the memory connectivity to the VVWR is shown in FIG. 21. It can be seen that the interconnect between the memory and the VWR is properly aligned (no turns or congestion) and therefore is energy optimized.

FIG. 22 shows the total capacitance of the different parts of the system (including both gate capacitances as well as interconnect capacitance):

Net capacitance=Σ(Capacitance of all nets in design)

Design Capacitance=Σ(Cgs+Cgd+Cgb) of all gates+Σ(Cap of all wires)

It can be seen from FIG. 22 that the design capacitance has reduced dramatically and hence the energy consumption has reduced drastically as well.

The foregoing description details certain embodiments of the invention. It will be appreciated, however, that no matter how detailed the foregoing appears in text, the invention may be practiced in many ways. It should be noted that the use of particular terminology when describing certain features or aspects of the invention should not be taken to imply that the terminology is being re-defined herein to be restricted to including any specific characteristics of the features or aspects of the invention with which that terminology is associated.

While the above detailed description has shown, described, and pointed out novel features of the invention as applied to various embodiments, it will be understood that various omissions, substitutions, and changes in the form and details of the device or process illustrated may be made by those skilled in the technology without departing from the spirit of the invention. The scope of the invention is indicated by the appended claims rather than by the foregoing description. All changes which come within the meaning and range of equivalency of the claims are to be embraced within their scope.

What is claimed is:

1. A signal processing device adapted for simultaneous processing of at least two loops, each loop having loop instructions, the signal processing device comprising:
a plurality of functional units capable of executing word- or subword-level operations on data, and the functional units being grouped into at least a first and a second processing units, the first and second processing units being connected to a first and second instruction memory, respectively, for receiving loop instructions of one of the loops and being connected to a first and a second memory controller, respectively, for fetching loop instructions from the corresponding instruction memory, wherein the first and second memory controllers are adapted for selecting its/their operation synchronized or unsynchronized with respect to each other, the selection being performed via the loop instructions.

2. The signal processing device in accordance with claim 1, wherein the memory controllers each at least comprises a slave loop counter.

3. The signal processing device in accordance with claim 2, wherein the signal processing device has a master counter for providing a timing signal and the slave loop counters are connected to the master counter for receiving the timing signal.

4. The signal processing device according to claim 3, wherein selecting their operation synchronized with respect to each other comprises synchronously incrementing the slave loop counters of at least two memory controllers upon reception of the timing signal.

5. The signal processing device according to claim 3, the timing signal comprising a sequence of time points, wherein the selection is performed via the loop instructions at every time point.

6. The signal processing device according to claim 3, wherein the master counter is a system clock generator.

7. The signal processing device according to claim 6, wherein the selection is performed at every clock cycle.

8. The signal processing device according to claim 2, wherein the slave loop counter is a hardware loop counter.

9. The signal processing device according to claim 2, wherein the slave loop counter is a software loop counter.

10. The signal processing device according to claim 1, wherein at least two functional units are connected to a shared data memory.

11. The signal processing device according to claim 10, wherein the shared data memory is a register.

12. A method of converting application code into execution code suitable for execution on an architecture adapted for simultaneous processing of at least two loops, each loop having loop instructions, the method comprising:
obtaining application code, the application code comprising at least a first and a second loop, each of the loops comprising loop instructions; and
converting at least part of the application code for the at least first and second loops, the converting comprising insertion of selection information into each of the loop instructions, the selection information being for fetching a next loop instruction of a first loop, synchronized or unsynchronized with the fetching of a next loop instruction of a second loop.

13. The method according to claim 12, wherein the architecture comprises a plurality of functional units capable of executing word- or subword-level operations on data, and the functional units being grouped into at least a first and a second processing units, the first and second processing units being connected to a first and second instruction memory, respectively, for receiving loop instructions of one of the loops and being connected to a first and a second memory controller, respectively, for fetching loop instructions from the corresponding instruction memory, wherein the first and second memory controllers are adapted for selecting its/their operation synchronized or unsynchronized with respect to each other, the selection being performed via the loop instructions.

14. The method according to claim 13, wherein the application code is converted such that, when executing the at least two loops simultaneously, each loop executing on one of the processing units, selecting of the fetching of next loop instructions is performed at time points of a time signal

15. The method according to claim 14, wherein the converting further comprises providing the time signal having time points.

16. The method according to claim 12, wherein the converting of at least part of the application code is based on time/data dependency analysis

17. The method according to claim 13, wherein at least part of the data communication between the loops is performed solely via a shared data memory to which at least two functional units are connected to a shared data memory.

18. The method according to claim 13, wherein the converting comprises inserting synchronization/alignment points between the at least two loops.

19. The method according to claim 18, wherein the points inserted are of at most a number of bits equal to the number of processing units minus one.

20. The method according to claim 12, wherein the data dependency analysis is based on a polyhedral representation of the at least two loops.

21. The method according to claim 12, wherein the application code is pre-processed to fit into a polyhedral representation before the converting of the application code.

22. The method according to claim 13, wherein the application code is pre-processed such that for at least two loops their instructions fit within one of the instruction memories.

23. A method of executing an application on a signal processing device adapted for simultaneous processing of at least two loops, each loop having loop instructions, the method comprising
executing the application on the signal processing device as a single process thread under control of a primary memory controller; and
dynamically switching the signal processing device into a device with at least two non-overlapping processing units, and splitting a portion of the application in at least two process threads, each process thread being executed simultaneously as a separate process thread on one of the processing units, each processing unit being controlled by a separate memory controller.

24. The method according to claim 23, wherein the architecture comprises a plurality of functional units capable of executing word- or subword-level operations on data, and the functional units being grouped into at least a first and a second processing units, the first and second processing units being connected to a first and second instruction memory, respectively, for receiving loop instructions of one of the loops and being connected to a first and a second memory controller, respectively, for fetching loop instructions from the corresponding instruction memory, wherein the first and second memory controllers are adapted for selecting its/their operation synchronized or unsynchronized with respect to each other, the selection being performed via the loop instructions.

25. The method according to claim 23, wherein the at least two process threads are loops.

26. The method according to claim 23, further comprising, for at least part of the application, adapting the process thread execution in accordance with synchronization points between the at least two process threads.

27. A microcomputer architecture comprising:
a microprocessor unit and a first memory unit, the microprocessor unit comprising a functional unit and at least one data register, the functional unit and the at least one data register being linked to a data bus internal to the microprocessor unit, the data register being a wide register comprising a plurality of second memory units which are capable to each contain one word, the wide register being adapted so that the second memory units are simultaneously accessible by the first memory unit, and at least part of the second memory units are separately accessible by the functional unit, wherein there is an alignment between the memory unit and the at least one data register.

28. The microcomputer architecture in accordance with claim 27, the memory unit having a plurality of sense amplifiers and the at least one data register having a plurality of flip flops, there being an alignment between each of the sense amplifiers and a corresponding flip flop.

29. A method of designing on a computer environment a digital system comprising a plurality of resources, the method comprising:
inputting a representation of the functionality of a digital system, the functionality being distributed over at least two of the resources interconnected by a resource interconnection; and
performing automated determination of an aspect ratio of at least one of the resources based on access activity of the resources while optimizing a cost criterion at least comprising resource interconnection power consumption cost.

30. The method according to claim 29, further comprising, for at least one of the resources, placement of communication pins based on access activity of the resources while optimizing a cost criterion at least comprising resource interconnection power consumption cost.

31. The method according to claim 29, further comprising, for at least two resources together, placement of communication pins based on access activity of the resources while optimizing a cost criterion at least comprising resource interconnection power consumption cost.

32. The method according to claim 29, wherein the representation is register transfer language (RTL) description.
